(19) United States
(12) Patent Application Publication
(10) Pub. No.: US 2019/0208109 A1
(43) Pub. Date: Jul. 4, 2019

(54) IMAGE PROCESSING APPARATUS, IMAGE PROCESSING METHOD, AND PROGRAM

(71) Applicant: SONY CORPORATION, Tokyo (JP)

(72) Inventors: Kengo HAYASAKA, Saitama (JP); Katsuhisa ITO, Tokyo (JP)

(73) Assignee: SONY CORPORATION, Tokyo (JP)

(21) Appl. No.: 16/334,180

(22) PCT Filed: Oct. 12, 2017
(86) PCT No.: PCT/JP2017/036999

§ 371 Date: Mar. 18, 2019

(30) Foreign Application Priority Data
Oct. 26, 2016 (JP) 2016-209186

(51) Int. Cl. H04N 5/232; G06T 5/50; G03B 13/36

(52) U.S. Cl. CPC H04N 5/23212; G03B 13/36; G06T 5/50

(57) ABSTRACT

The present technology relates to an image processing apparatus, an image processing method, and a program which can realize a wide variety of refocusing. A light condensing processing unit sets a shift amount for shifting pixels of images of a plurality of viewpoints, shifts the pixels of the images of the plurality of viewpoints according to the shift amount to be added to perform light condensing processing of generating a processing result image focused on a plurality of focusing points with different distances in a depth direction. The shift amount is set for each of pixels of the processing result image. The present technology can be applied to, for example, a case where an image refocused is obtained from the images of the plurality of viewpoints, and the like.

### TECHNICAL FIELD

The present technology relates to an image processing apparatus, an image processing method, and a program, and particularly to an image processing apparatus, an image processing method, and a program which can realize, for example, a wide variety of refocusing.

### BACKGROUND ART

Light field technology has been proposed to reconstruct, for example, images refocused from images of a plurality of viewpoints, in other words, images and the like captured by changing the focus of an optical system (e.g., see Non-Patent Document 1).

For example, Non-Patent Document 1 describes a refocusing method using a camera array constituted by 100 cameras.

### CITATION LIST

### Non-Patent Document

Non-Patent Document 1: Bennett Wilburn et al., “High Performance Imaging Using Large Camera Arrays”

### SUMMARY OF THE INVENTION

### Problems to be Solved by the Invention

In the refocusing described in Non-Patent Document 1, since the focusing plane constituted by a group of spatial points (points in the real space) to be focused is one plane with a fixed distance in the depth direction, an image focused on a subject on the focusing plane, which is that one plane, can be obtained.

However, as for the refocusing in the future, it is expected that the need for realizing a wide variety of refocusing will increase.

The present technology has been made in light of such a situation and can realize a wide variety of refocusing.

### Solutions to Problems

An image processing apparatus or a program of the present technology is an image processing apparatus including a light condensing processing unit that sets a shift amount for each of pixels of a processing result image when performing light condensing processing of generating the processing result image focused on a plurality of focusing points with different distances in a depth direction by setting the shift amount for shifting pixels of images of a plurality of viewpoints, and shifting the pixels of the images of the plurality of the viewpoints according to the shift amount to be added, or a program for causing a computer to function as such an image processing apparatus.

The image processing method of the present technology is an image processing method including a step of setting a shift amount for each of pixels of a processing result image when performing light condensing processing of generating the processing result image focused on a plurality of focusing points with different distances in a depth direction by setting the shift amount for shifting pixels of images of a plurality of viewpoints, and shifting the pixels of the images of the plurality of the viewpoints according to the shift amount to be added.

In the image processing apparatus, the image processing method, and the program of the present technology, a shift amount is set for each of pixels of a processing result image when light condensing processing of generating the processing result image focused on a plurality of focusing points with different distances in a depth direction is performed by setting the shift amount for shifting pixels of images of a plurality of viewpoints, and shifting the pixels of the images of the plurality of the viewpoints according to the shift amount to be added.

Note that the image processing apparatus may be an independent apparatus or an internal block constituting one apparatus.

Furthermore, the program can be provided by being transmitted via a transmission medium or by being recorded on a recording medium.

### Effects of the Invention

According to the present technology, a wide variety of refocusing can be realized.

Note that the effects described herein are not necessarily limited, and any one of the effects described in the present disclosure may be exerted.

### BRIEF DESCRIPTION OF THE DRAWINGS

FIG. 1 is a block diagram showing a configuration example of an image processing system according to one embodiment, to which the present technology is applied.

FIG. 2 is a rear view showing a configuration example of the image capturing apparatus 11.

FIG. 3 is a rear view showing another configuration example of the image capturing apparatus 11.

FIG. 4 is a block diagram showing a configuration example of the image processing apparatus 12.

FIG. 5 is a flowchart for explaining an example of the processing of the image processing system.

FIG. 6 is a diagram for explaining an example of generating the interpolation images by the interpolation unit 32.

FIG. 7 is a diagram for explaining an example of generating the disparity map in the disparity information generation unit 31.

FIG. 8 is a diagram for explaining an overview of refocusing by the light condensing processing performed by the light condensing processing unit 33.

FIG. 9 is a diagram for explaining an example of the disparity conversion.

FIG. 10 is a diagram for explaining an overview of a simple refocusing mode.

FIG. 11 is a diagram for explaining an overview of a tilt refocusing mode.

FIG. 12 is a diagram for explaining an overview of a multifocal refocusing mode.

FIG. 13 is a flowchart for explaining an example of the light condensing processing performed by the light condensing processing unit 33 in a case where the refocusing mode is set to the simple refocusing mode.

FIG. 14 is a view for explaining tilt image capturing with an actual camera.

FIG. 15 is a view showing examples of capturing images captured by the normal image capturing and the tilt image capturing with an actual camera.

FIG. 16 is a plan view showing an example of an image capturing situation by the image capturing apparatus 11.

FIG. 17 is a plan view showing an example of the viewpoint image.

FIG. 18 is a plan view for explaining an example of setting of the focusing plane in the tilt refocusing mode.

FIG. 19 is a view for explaining a first setting method for the focusing plane.

FIG. 20 is a view for explaining a second setting method for the focusing plane.

FIG. 21 is a flowchart for explaining an example of the light condensing processing performed by the light condensing processing unit 33 in a case where the refocusing mode is set to the tilt refocusing mode.

FIG. 22 is a plan view for explaining an example of setting of the focusing planes in the multifocal refocusing mode.

FIG. 23 is a diagram for explaining an example of a selection method of selecting one focusing plane from the first focusing plane and the second focusing plane.

FIG. 24 is a flowchart for explaining an example of the light condensing processing performed by the light condensing processing unit 33 in a case where the refocusing mode is set to the multifocal refocusing mode.

FIG. 25 is a block diagram showing a configuration example of a computer according to one embodiment, to which the present technology is applied.

### MODE FOR CARRYING OUT THE INVENTION

### One Embodiment of Image Processing System to which the Present Technology is Applied

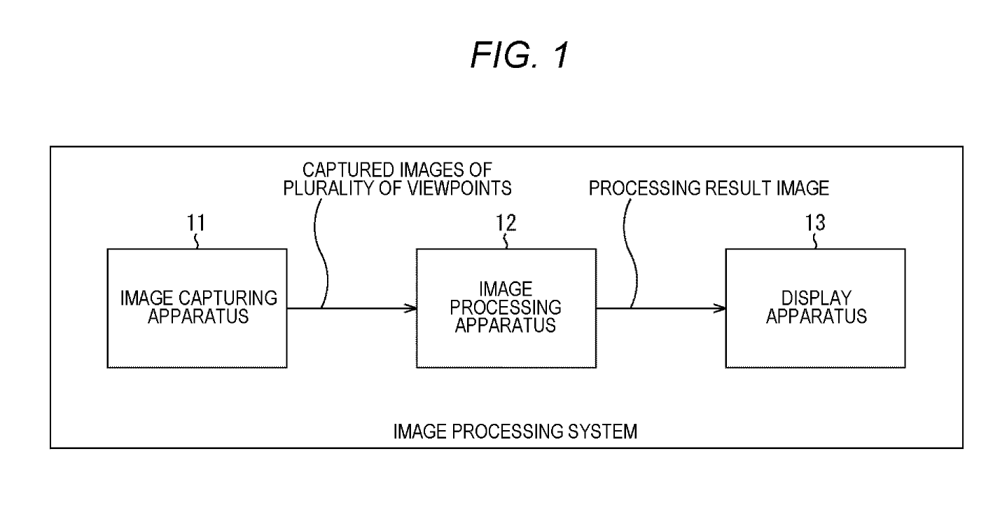

FIG. 1 is a block diagram showing a configuration example of an image processing system according to one embodiment, to which the present technology is applied.

In FIG. 1, the image processing system has an image capturing apparatus 11, an image processing apparatus 12, and a display apparatus 13.

The image capturing apparatus 11 captures image of a subject from a plurality of viewpoints and supplies the image processing apparatus 12 with the captured images in, for example, (substantially) deep focus of the plurality of viewpoints obtained as a result.

The image processing apparatus 12 performs image processing, such as refocusing for generating (reconstructing) an image focused on any subjects, by using the captured images of the plurality of viewpoints from the image capturing apparatus 11 and supplies display apparatus 13 with a processing result images obtained as a result of the image processing.

The display apparatus 13 displays the processing result image from the image processing apparatus 12.

Note that all of the image capturing apparatus 11, the image processing apparatus 12, and the display apparatus 13 constituting the image processing system in FIG. 1 can be built into an independent apparatus including, for example, a digital (still/video) camera, a mobile terminal such as a smartphone, or the like.

Furthermore, the image capturing apparatus 11, the image processing apparatus 12, and the display apparatus 13 can be each separately built into an independent apparatus.

Moreover, any two of and the remaining one of the image capturing apparatus 11, the image processing apparatus 12, and the display apparatus 13 can be each separately built into an independent apparatuses.

For example, the image capturing apparatus 11 and the display apparatus 13 can be built into a mobile terminal possessed by a user, and the image processing apparatus 12 can be built into a server on a cloud.

Furthermore, part of the blocks of the image processing apparatus 12 can be built into a server on a cloud, and the remaining blocks of the image processing apparatus 12, the image capturing apparatus 11, and the display apparatus 13 can be built into a mobile terminal.

<Configuration Example of Image Capturing Apparatus 11>

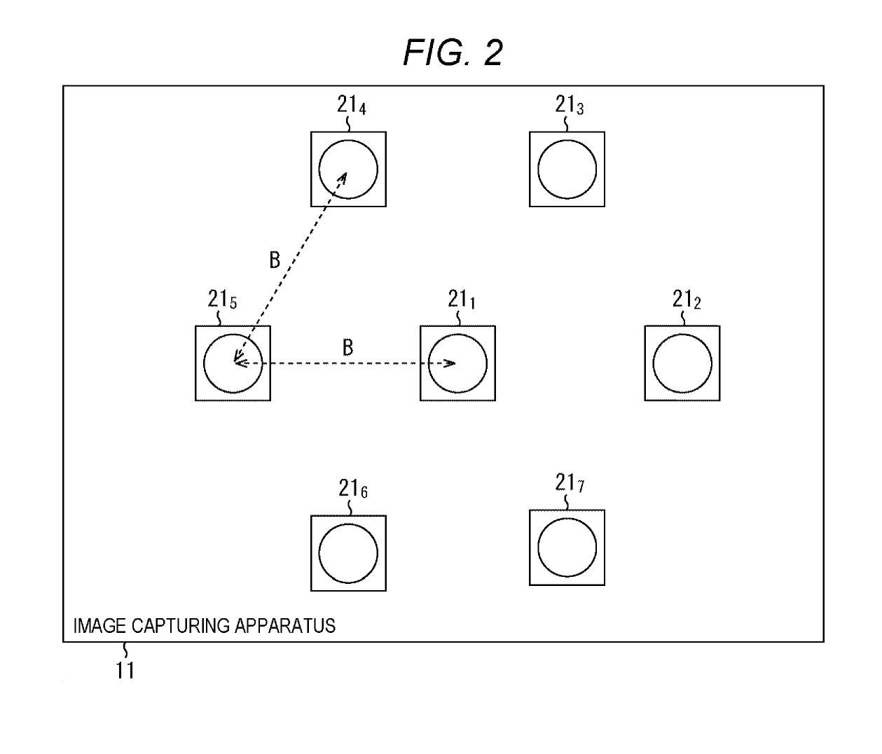

FIG. 2 is a rear view showing a configuration example of the image capturing apparatus 11 in FIG. 1.

The image capturing apparatus 11 has, for example, a plurality of camera units (hereinafter, also simply referred to as cameras) 21ᵢ that capture images having RGB values as pixel values, and captures capturing images of a plurality of viewpoints by the plurality of cameras 21ᵢ.

In FIG. 2, the image capturing apparatus 11 has a plurality of, for example, seven cameras 21₁, 21₂, 21₃, 21₄, 21₅, 21₆, and 21₇, and these seven cameras 21₁ to 21₇ are arranged on a two-dimensional plane.

Moreover, as for the seven cameras 21₁ to 21₇ in FIG. 2, one of them, for example, the camera 21₁ is centered, and the other six cameras 21₂ to 21₇ are arranged around the camera 21₁ so as to form a regular hexagon.

Therefore, the distance between the any one camera 21ᵢ (i=1, 2, . . . , 7) out of the seven cameras 21₁ to 21₇ and the other one camera 21ⱼ closest to the camera 21ᵢ (j=1, 2, . . . , 7) (between the optical axes) is the same distance B in FIG. 2.

The distance B between the cameras 21ᵢ and 21ⱼ can be, for example, about 20 mm. In this case, the size of the image capturing apparatus 11 can be about a size of a card such as an IC card.

Note that the number of the cameras 21ᵢ constituting the image capturing apparatus 11 is not limited to seven and can be the number that is two or more and six or less or the number that is eight or more.

Furthermore, the plurality of cameras 21ᵢ can be arranged at any positions in the image capturing apparatus 11 in addition to being arranged to form a regular polygon such as a regular hexagon as described above.

Here, hereinafter, among the cameras 21₁ to 21₇, the camera 21₁ arranged at the center is also referred to as a reference camera 21₁, and the cameras 21₂ to 21₇ arranged around the reference camera 21₁ are also referred to as peripheral cameras 21₂ to 21₇.

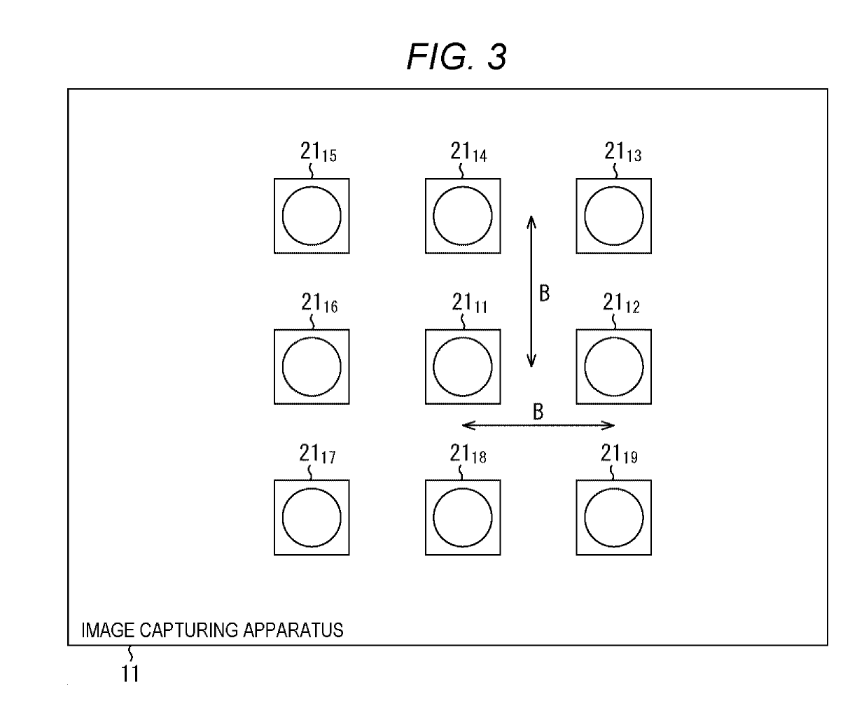

FIG. 3 is a rear view showing another configuration example of the image capturing apparatus 11 in FIG. 1.

In FIG. 3, the image capturing apparatus 11 is constituted by nine cameras 21₁₁ to 21₁₉, and the nine cameras 21₁₁ to 21₁₉ are arranged in 3×3 by rows×columns. As for the 3×3 cameras 2 (i=11, 12, . . . 19), the cameras 2ᵢ (j=11, 12, . . . , 19) adjacent to the upper, Lower, left, or right thereof are arranged apart by a distance B.

He re, the image capturing apparatus 11 is constituted by, for example, the seven cameras 21₁ to 21₇ as shown in FIG. 2 hereinafter unless otherwise specified.

Furthermore, the viewpoint of the reference camera 21₁ is also referred to as a reference viewpoint, and a captured image PL1 captured by the reference camera 21₁ is also referred to as a reference image PL1. Moreover, the capturing images PL#i captured by the peripheral cameras 21ᵢ are also referred to as peripheral images PL#i.

Note that the image capturing apparatus 11 can be constituted by not only the plurality of cameras 21ᵢ as shown in FIGS. 2 and 3, but also by, for example, using a micro lens array (MLA) as described in Ren.Ng, seven others, “Light Field Photography with a Hand-Held Plenoptic Camera”, Stanford Tech Report CTSR 2005-02. Even in a case where the image capturing apparatus 11 is constituted by using the MLA, it is possible to substantially obtain capturing images captured from a plurality of viewpoints.

Furthermore, the method of capturing the capturing images of a plurality of viewpoints is not limited to the method of constituting the image capturing apparatus 11 with the plurality of cameras 21ᵢ or the method of constituting the image capturing apparatus 11 by using the MLA.

<Configuration Example of Image Processing Apparatus 12>

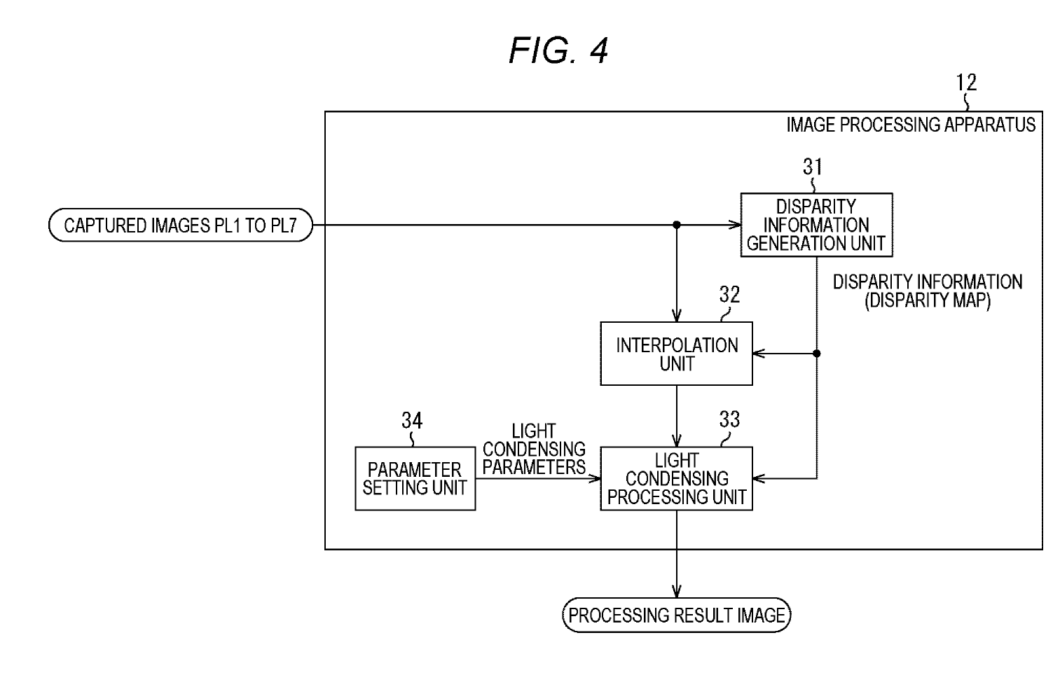

FIG. 4 is a block diagram showing a configuration example of the image processing apparatus 12 in FIG. 1.

In FIG. 4, the image processing apparatus 12 has a disparity information generation unit 31, an interpolation unit 32, a light condensing processing unit 33, and a parameter setting unit 34.

From the image capturing apparatus 11, the image processing apparatus 12 is supplied with the capturing images PL1 to PL7 of seven viewpoints captured by the cameras 21₁ to 21₇.

In the image processing apparatus 12, the captured images PL#i (here, i=1, 2, . . . , 7) are supplied to the disparity information generation unit 31 and the interpolation unit 323.

The disparity information generation unit 31 obtains disparity information by using the captured images PL#i supplied from the image capturing apparatus 11 and supplies the disparity information to the interpolation unit 32 and the light condensing processing unit 33.

In other words, for example, the disparity information generation unit 31 performs processing of obtaining the disparity information on each of the captured images PL#i supplied from the image capturing apparatus 11 with respect to other captured images PL#j as image processing on the captured images PL#i of the plurality of viewpoints. Then, the disparity information generation unit 31, for example, generates a map in which the disparity information is registered for each (position of) pixel of the captured images and supplies the map to the interpolation unit 32 and the light condensing processing unit 33.

Here, as the disparity information, disparity expressed by a pixel number and any information that can be converted into disparity such as a distance in the depth direction corresponding to the disparity can be employed. In the present embodiment, for example, the disparity is employed as the disparity information, and the disparity map, in which the disparity is registered, is generated as the map, in which the disparity information is registered, in the disparity information generation unit 31.

The interpolation unit 32 uses the captured images PL1 to PL7 of the seven viewpoints of the cameras 21₁ to 21₇ from the image capturing apparatus 11 and the disparity map from the disparity information generation unit 31 to generate, by interpolation, images that could be obtained if the image capturing were performed from viewpoints other the seven viewpoints of the cameras 21₁ to 21₇.

Here, by light condensing processing performed by the light condensing processing unit 33 as described later, the image capturing apparatus 11 constituted by the plurality of cameras 21₁ to 21₇ can function as a virtual lens with the cameras 21₁ to 21₇ as synthetic apertures. As for the image capturing apparatus 11 in FIG. 2, the synthetic apertures of the virtual lens have a substantially circular shape with a diameter of approximately 2B connecting the optical axes of the peripheral cameras 21₂ to 21₇.

For example, the interpolation unit 32 generates, by interpolation, images of 21×21−7 viewpoints other than the seven viewpoints of the cameras 21₁ to 21₇ among 21×21 viewpoints with a plurality of substantially equally spaced points within a square having the diameter 2B of the virtual lens as one side (or a square inscribed in the synthetic apertures of the virtual lens), in other words, for example, with 21×21 points by rows×columns as viewpoints.

Then, the interpolation unit 32 supplies the light condensing processing unit 33 with the captured images PL1 to PL7 of the seven viewpoints of the cameras 21₁ to 21₇ and the images of the 21×21−7 viewpoints generated by the interpolation using the captured images.

Here, in the interpolation unit 32, the images generated by the interpolation using the captured images are also referred to as interpolation images.

Furthermore, the images of the total of 21×21 viewpoints of the captured images PL1 to PL7 of the seven viewpoints of the cameras 21₁ to 21₇ and the interpolation images of the 21×21−7 viewpoints, which are supplied from the interpolation unit 32 to the light condensing processing unit 33, are also referred to as viewpoint images.

It can be considered that the interpolation in the interpolation unit 32 is processing of generating viewpoint images of a larger number of viewpoints (here, 21×21 viewpoints) from the captured images PL1 to PL7 of the seven viewpoints of the cameras 21₁ to 21₇. This processing of generating the viewpoint images of a large number viewpoints can be grasped as processing of reproducing light beams, which are incident on the virtual lens with the cameras 21₁ to 21₇ as the synthetic apertures, from the real space points in the real space.

By using the viewpoint images of the plurality of viewpoints from the interpolation unit 32, the light condensing processing unit 33 condenses the light beams from a subject, which have passed through the optical system such as a lens, on an image sensor or a film in an actual camera and performs the light condensing processing which is image processing equivalent to forming an image of the subject.

In the light condensing processing of the light condensing processing unit 33, refocusing for generating (reconstructing) an image focused on any subject is performed. The refocusing is performed by using the disparity map from the disparity information generation unit 31 and the light condensing parameters from the parameter setting unit 34.

The image obtained by the light condensing processing of the light condensing processing unit 33 is outputted (to the display apparatus 13) as the processing result image.

The parameter setting unit 34 sets a pixel of the captured images PL#i (e.g., the reference image PL1) at a position designated by manipulation of the user on a manipulation unit (not shown), a predetermined application, or the like as a focusing target pixel to be focused (where the subject appears) and supplies the pixel as a (part of) light condensing parameter to the light condensing processing unit 33.

Note that the image processing apparatus 12 may be configured as a server or configured as a client. Moreover, the image processing apparatus 12 may be configured as a server-client system. In a case where the image processing apparatus 12 is configured as a server-client system, any part of blocks of the image processing apparatus 12 can be configured as a server, and the remaining blocks can be configured as a client.

<Processing of Image Processing System>

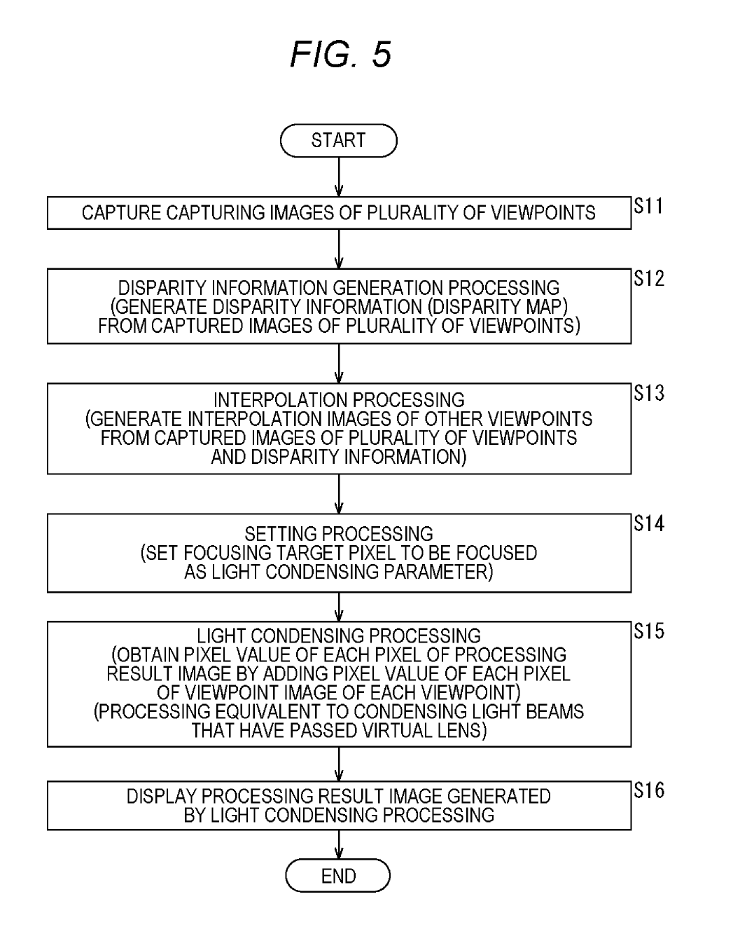

FIG. 5 is a flowchart for explaining an example of the processing of the image processing system in FIG. 1.

In step S11, the image capturing apparatus 11 captures the capturing images PL1 to PL7 of the seven viewpoints as the plurality of viewpoints. The captured images PL#i are supplied to the disparity information generation unit 31 and the interpolation unit 32 of the image processing apparatus 12 (FIG. 4).

Then, the processing proceeds from step S11 to step S12, and the disparity information generation unit 31 obtains the disparity information by using the captured images PL#i from the image capturing apparatus 11 and performs the disparity information generation processing of generating the disparity map in which the disparity information is registered.

The disparity information generation unit 31 supplies the disparity map obtained by the disparity information generation processing to the interpolation unit 32 and the light condensing processing unit 33, and the processing proceeds from step S12 to step S13.

In step S13, the interpolation unit 32 uses the captured images PL1 to PL7 of the seven viewpoints of the cameras 21₁ to 21₇ from the image capturing apparatus 11 and the disparity map from the disparity information generation unit 31 to perform the interpolation processing of generating the interpolation images of the plurality of viewpoints other the seven viewpoints of the cameras 21₁ to 21₇.

Moreover, the interpolation unit 32 supplies the light condensing processing unit 33 with the captured images PL1 to PL7 of the seven viewpoints of the cameras 21₁ to 21₇ from the image capturing apparatus 11 and the interpolation images of the plurality of viewpoints obtained by the interpolation processing as the viewpoint images of the plurality of viewpoints, and the processing proceeds from step S13 to step S14.

In step S14, the parameter setting unit 34 performs the setting processing of setting the pixel of the reference image PL1 at the position designated by the user's manipulation or the like as the focusing target pixel to be focused.

The parameter setting unit 34 supplies the light condensing processing unit 33 with (the information on) the focusing target pixel obtained by the setting processing as the light condensing parameter, and the processing proceeds from step S14 to step S15.

Here, for example, the parameter setting unit 34 causes the display apparatus 13 to display, for example, the reference image PL1 from among the captured images PL1 to PL7 of the seven viewpoints from the image capturing apparatus 11 together with a message prompting the designation of a subject to be focused. Then, the parameter setting unit 34 waits until the user designates the position on (the subject appearing on) the reference image PL1 displayed on the display apparatus 13, and sets the pixel of the reference image PL1 at the position designated by the user as the focusing target pixel.

As described above, in addition to being set according to the designation by the user, the focusing target pixel can be set, for example, according to designation from an application, designation by a predetermined rule, or the like.

For example, it is possible to set, as the focusing target pixel, a pixel in which a subject with motion of a predetermined speed or more or a subject moving continuously for a predetermined time or more appears.

In step S15, the light condensing processing unit 33 uses the viewpoint images of the plurality of viewpoints from the interpolation unit 32, the disparity map from the disparity information generation unit 31, and the focusing target pixel as the light condensing parameter from the parameter setting unit 34 to perform the light condensing processing equivalent to condensing the light beams from the subject, which have passed through the virtual lens with the cameras 21₁ to 21₇ as the synthetic apertures, on a virtual sensor (not shown).

The substance of the virtual sensor where the light beams that have passed through the virtual lens are condensed is, for example, a memory (not shown). In the light condensing processing, the pixel values of the viewpoint images of the plurality of viewpoints as luminance of the light beams condensed on the virtual sensor are added to (the stored values of) the memory as the virtual sensor so that the pixel values of the image obtained by condensing the light beams that have passed through the virtual lens are obtained.

In the light condensing processing of the light condensing processing unit 33, a reference shift amount BV, which is a pixel shift amount for pixel-shifting the pixels of the viewpoint images of the plurality of viewpoints and will be described later, is set, and the pixels of the viewpoint images of the plurality of viewpoints are pixel-shifted according to the reference shift amount BV and added so that each pixel value of the processing result image focused on the plurality of focusing points with different distances in the depth direction is obtained, and the processing result image is generated.

Here, the focusing point is a real space point in focus in the real space, and, in the light condensing processing of the light condensing processing unit 33, the focusing plane which is the plane as a group of the focusing points is set by using the focusing target pixel as the light condensing parameter from the parameter setting unit 34.

Furthermore, in the light condensing processing of the light condensing processing unit 33, the reference shift amount BV is set for each pixel of the processing result image.

As described above, by setting the reference shift amount BV for each pixel of the processing result image, it is possible to realize a wide variety of refocusing, in other words, tilt refocusing, multifocal refocusing, and the like, which will be described later.

The light condensing processing unit 33 supplies the display apparatus 13 with the processing result image obtained as a result of the light condensing processing, and the processing proceeds from step S15 to step S16.

In step S16, the display apparatus 13 displays the processing result image from the light condensing processing unit 33.

Note that the setting processing in step S14 is performed between the interpolation processing in step S13 and the light condensing processing in step S15 in FIG. 5, but the setting processing can be performed at any timing between immediately after the capturing images PL1 to PL7 of the seven viewpoints are captured in step S11 and immediately before the light condensing processing in step S15.

Furthermore, the image processing apparatus 12 (FIG. 4) can be constituted only by the light condensing processing unit 33.

For example, in a case where the light condensing processing of the light condensing processing unit 33 is performed by using the capturing images captured by the image capturing apparatus 11 without using the interpolation images, the image processing apparatus 12 can be constituted without being provided with the interpolation unit 32. However, in a case where the light condensing processing is performed by using not only the captured images but also the interpolation images, occurrence of ringing on a subject not focused can be suppressed in the processing result image.

Furthermore, for example, in a case where the disparity information on the capturing images of the plurality of viewpoints captured by the image capturing apparatus 11 can be generated by an external apparatus by using a distance sensor or the like and the disparity information can be acquired from the external apparatus, the image processing apparatus 12 can be constituted without being provided with the disparity information generation unit 31.

Moreover, for example, in a case where the focusing plane is set according to a predetermined rule in the light condensing processing unit 33, the image processing apparatus 12 can be constituted without being provided with the parameter setting unit 34.

<Generation of Interpolation Images>

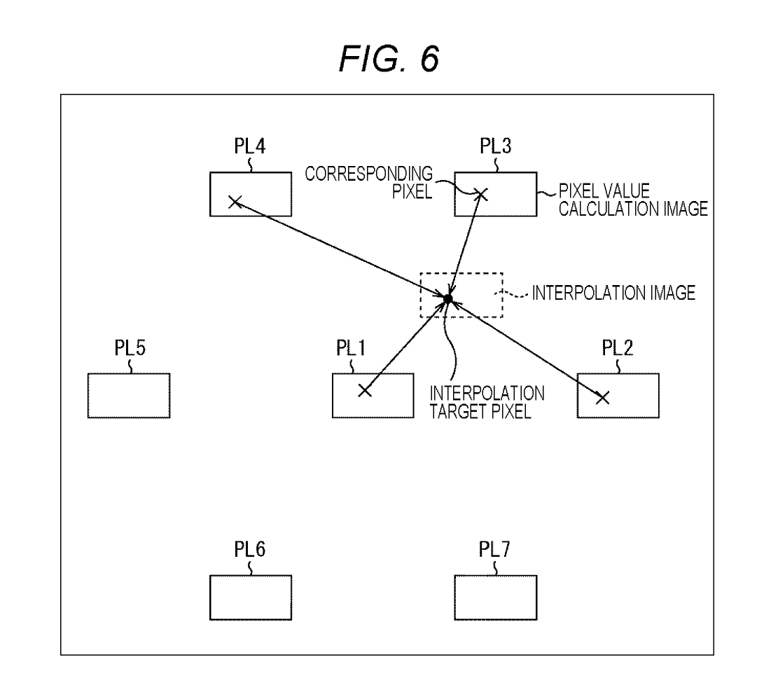

FIG. 6 is a diagram for explaining an example of generating the interpolation images by the interpolation unit 32 in FIG. 4.

In a case of generating an interpolation image of a certain viewpoint, the interpolation unit 32 sequentially selects pixels of the interpolation image as interpolation target pixels which are interpolation targets. Moreover, the interpolation unit 32 selects all of the captured images PL1 to PL7 of the seven viewpoints or some of the captured images PL#i of the viewpoints close to the viewpoint of the interpolation image as pixel value calculation images used for the calculation of the pixel values of the interpolation target pixels. By using the disparity map from the disparity information generation unit 31 and the viewpoints of the interpolation images, the interpolation unit 32 obtains a corresponding pixel (a pixel in which a spatial point the same as the spatial point that would appear in the interpolation target pixel if an image were captured from the viewpoint of the interpolation image) which corresponds to the interpolation target pixel from each of the captured images PL#i of the plurality of viewpoints selected as the pixel value calculation images.

Then, the interpolation unit 32 weights and adds the pixel values of the corresponding pixels and obtains the weighted additional values obtained as a result as the pixel values of the interpolation target pixels.

The weight used for the weighted addition of the pixel values of the corresponding pixels can be a value inversely proportional to the distance between the viewpoints of the captured images PL#i as the pixel value calculation images having the corresponding pixels and the viewpoint of the interpolation image having the interpolation target pixel.

Note that, in a case where intense light with directivity appears in the captured images PL#i, the interpolation image similar to the image, which could be obtained if the actual image were captured from the viewpoint of the interpolation image, can be obtained by selecting the captured images PL#i of some viewpoints such as three viewpoints or four viewpoints close to the viewpoint of the interpolation image as the pixel value calculation images rather than by selecting all of the captured images PL1 to PL7 of the seven viewpoints as the pixel value calculation images.

<Generation of Disparity Map>

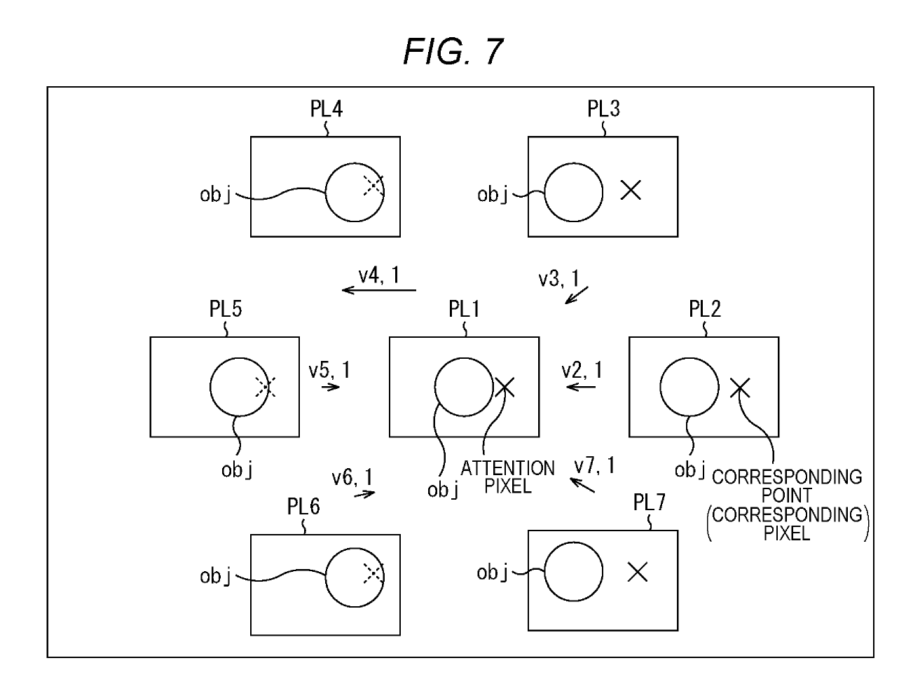

FIG. 7 is a diagram for explaining an example of generating the disparity map in the disparity information generation unit 31 in FIG. 4.

In other words, FIG. 7 shows examples of the capturing images PL1 to PL7 captured by the cameras 21₁ to 21₇ of the image capturing apparatus 11.

In FIG. 7, a predetermined object obj as the foreground appears on the front side of a predetermined background in the captured images PL1 to PL7. Since each of the captured images PL1 to PL7 has a different viewpoint, for example, the position (the position on the captured image) of the object obj appearing in each of the captured images PL2 to PL7 is shifted from the position of the object obj appearing in the captured image PL1 by the differences of the viewpoints.

Now, the viewpoints (position) of the camera 21ᵢ, in other words, the viewpoints of the captured images PL#i captured by the cameras 21ᵢ are denoted by vp#i.

For example, in a case of generating a disparity map of the viewpoint vp1 of the captured image PL1, the disparity information generation unit 31 sets the captured image PL1 as an attention image PL1 which is paid attention. Moreover, the disparity information generation unit 31 sequentially selects each pixel of the attention image PL1 as an attention pixel which is paid attention, and detects the corresponding pixel (corresponding point) corresponding to the attention pixel from each of the other captured images PL2 to PL7.

As a method of detecting the corresponding pixel corresponding to the attention pixel of the attention image PL1 from each of the captured images PL2 to PL7, for example, there is a method utilizing the principle of triangulation such as stereo matching or multi-baseline stereo.

Here, vectors representing the positional shifts of the corresponding pixels of the captured images PL#i with respect to the attention pixel of the attention image PL1 are referred to as disparity vectors v#i, 1.

The disparity information generation unit 31 obtains the disparity vectors v2, 1 to v7, 1 of the captured images PL2 to PL7, respectively. Then, for example, the disparity information generation unit 31 performs a majority decision on the magnitude of the disparity vectors v2, 1 to v7, 1 and obtains the magnitude of the disparity vector v#i, 1 that won the majority decision as the magnitude of the disparity of (the position of) the attention pixel.

Here, in a case where the distances between the reference camera 21₁ that captures the attention image PL1 and each of the peripheral cameras 21₂ to 21₇ that capture the capturing images PL2 to PL7 are the same distance B in the image capturing apparatus 11 as described with FIG. 2, when the real space point appearing in the attention pixel of the attention image PL1 also appears in the captured images PL2 to PL7, vectors with different orientations and equal magnitude are obtained as the disparity vectors v2, 1 to v7, 1.

In other words, in this case, the disparity vectors v2, 1 to v7, 1 are vectors of equal magnitude in the direction opposite to the directions of the viewpoints vp2 to vp7 of the other captured images PL2 to PL7 with respect to the viewpoint vp of the attention image PL1.

However, among the captured images PL2 to PL7, there may be an image in which occlusion occurs, in other words, an image in which the real space point appearing in the attention pixel of the attention image P11 is hidden behind the foreground and does not appear.

For a captured image PL#i in which the real space point appearing in the attention pixel of the attention image PL1 does not appear (hereinafter, also referred to as an occlusion image), it is difficult to detect a correct pixel as the corresponding pixel corresponding to the attention pixel.

Therefore, for the occlusion image PL#i, a disparity vector v#i, 1 with magnitude different from that of the disparity vectors v#j, 1 of the captured images PL#j, in which the real space point appearing in the attention pixel of the attention image PL1 appears, is obtained.

Among the captured images PL2 to PL7, the number of images in which occlusion occurs in the attention pixel is estimated to be less than the number of images in which occlusion does not occur. Thereupon, as described above, the disparity information generation unit 31 performs a majority decision on the magnitude of the disparity vectors v2, 1 to v7, 1 and obtains the magnitude of the disparity vector v#i, 1 that won the majority decision as the magnitude of the disparity of the attention pixel.

In FIG. 7, among the disparity vectors v2, 1 to v7, 1, the three disparity vectors v2, 1, v3, 1, and v7, 1 are vectors with equal magnitude. Furthermore, for each of the disparity vectors v4, 1, v5, 1 and v6, 1, there are not disparity vectors with equal magnitude.

Therefore, the magnitude of the three disparity vectors v2, 1, v3, 1, and v7, I are obtained as the magnitude of the disparity of the attention pixel.

Note that the direction of the disparity of the attention pixel of the attention image PL1 with respect to any captured images PL#i can be recognized from the positional relationship (the direction from the viewpoint vp1 to the viewpoint vp#i, or the like) between the viewpoint vp1 (the position of the camera 21₁) of the attention image PL1 and the viewpoints vp#i (the positions of the cameras 21ᵢ) of the captured images PL#i.

The disparity information generation unit 31 sequentially selects each pixel of the attention image PL1 as the attention pixel and obtains the magnitude of the disparity. Then, the disparity information generation unit 31 generates, as the disparity map, a map in which the magnitude of the disparity of the pixel is registered with respect to the position (xy coordinate) of each pixel of the attention image PL1. Thus, the disparity map is a map (table) in which the position of the pixel is associated with the magnitude of the disparity of the pixel.

The disparity maps of the viewpoints vp#i of the other captured images PL#i can also be generated in a manner similar to the disparity map of the viewpoint vp#1.

However, to generate the disparity maps of the viewpoints vp#i other than the viewpoint vp#1, the majority decision on the disparity vector is performed by adjusting the magnitude of disparity vectors on the basis of the positional relationships (the positional relationships between the cameras 21ᵢ and 21ⱼ) (the distances between the viewpoints vp#i and the viewpoints vp#j) between the viewpoints vp#i of the captured images PL#i and the viewpoints vp#j of the captured images PL#j other than the captured image PL#i.

In other words, for example, in a case of generating the disparity map with the captured image PL5 as an attention image PL5 for the image capturing apparatus 11 in FIG. 2, the magnitude of the disparity vector obtained between the attention image PL5 and the captured image PL2 is double that of the disparity vector obtained between the attention image PL5 and the captured image PL1.

This is because the baseline length, which is the distance between the optical axes of the camera 21₅ that captures the attention image PL5 and the camera 21₁ that captures the capturing image PL1, is the distance B, whereas the baseline length between the camera 21₅ that captures the attention image PL5 and the camera 21₂ that captures the capturing image PL2 is the distance 2B.

Thereupon, for example, the distance B, which is the baseline length between the reference camera 21₁ and the other cameras 21ᵢ, is now referred to as a reference baseline length which is a reference for obtaining the disparity. Majority decision on the disparity vector is performed by adjusting the magnitude of the disparity vectors such that the baseline lengths are converted into a reference baseline length B.

In other words, for example, the baseline length B between the camera 21₅ that captures the attention image PL5 and the reference camera 21₁ that captures the capturing image PL1 is equal to the reference baseline length B so that the magnitude of the disparity vector obtained between the attention image PL5 and the captured image PL10 is adjusted to one time.

Furthermore, for example, the baseline length 2B between the camera 21₅ that captures the attention image PL5 and the camera 21₂ that captures the capturing image PL2 is equal to twice the reference baseline length B so that the magnitude of the disparity vector obtained between the attention image PL5 and the captured image PL2 is adjusted to half times (double a value of a ratio of the reference baseline length B to the baseline length 2B between the camera 21₅ and the camera 21₂).

Likewise, the magnitude of the disparity vectors obtained between the attention image PL5 and other captured images PL#i are adjusted to double a value of a ratio to the reference baseline length B.

Then, the majority decision on the disparity vector is performed by using the disparity vectors after the magnitude thereof is adjusted.

Note that, in the disparity information generation unit 31, the disparity of (each pixel of) the captured images PL#i can be obtained, for example, with the precision of the pixels of the capturing images captured by the image capturing apparatus 11. Furthermore, the disparity of the captured images PL#i can be obtained, for example, with the precision of pixel or less (e.g., the precision of a subpixel such as a ¼ pixel), which is precision finer than that of the pixel of those captured images PL#i.

In a case of obtaining the disparity with the precision of pixel or less, in the processing using the disparity, the disparity with the precision of pixel or less can be directly used, or the figures below the decimal point of the disparity with the precision of pixel or less can be truncated, rounded up, rounded off, or the like to be used as an integer.

Here, the magnitude of the disparity registered in the disparity map is also referred to as registration disparity hereinafter. For example, in a case of representing a vector as disparity in a two-dimensional coordinate system in which the left-to-right axis is the x-axis and the down-to-up axis is the y-axis, the registration disparity is equal to the x component of the disparity (the vector representing a pixel shift from the pixel of the reference image PL1 to the corresponding pixel of the captured image PL5 corresponding to the pixel) between each pixel of the reference image PL1 and the captured image PL5 of the viewpoint adjacent to the left of the reference image PL1.

<Refocusing by Light Condensing Processing>

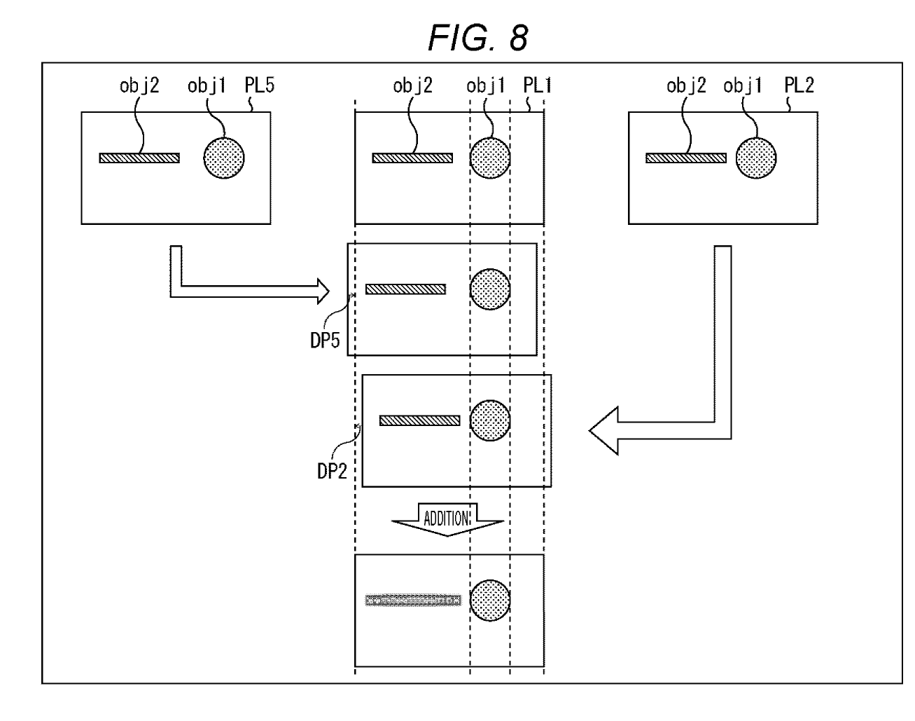

FIG. 8 is a diagram for explaining an overview of refocusing by the light condensing processing performed by the light condensing processing unit 33 in FIG. 4.

Note that, in FIG. 8, in order to simplify the explanation, three images, the reference image PL1, the captured image PL2 of the viewpoint adjacent to the right of the reference image PL1, and the captured image PL5 of the viewpoint adjacent to the left of the reference image PL1, are used as the viewpoint images of the plurality of viewpoints used in the light condensing processing.

In FIG. 8, two objects obj1 and obj2 appear in the captured images PL1, PL2, and PL5. For example, the object obj is positioned on the front side, and the object obj2 is positioned on the far side.

For example, refocusing (focusing) on the object obj1 is now performed to obtain an image viewed from the reference viewpoint of the reference image PL1 as the processing result image after the refocusing.

Here, the viewpoint of the processing result image with respect to pixel of the captured image PL1, in which the object obj1 appears, in other words, the disparity of (the corresponding pixel of the reference image PL1 of) the reference viewpoint is denoted here by DP1. Furthermore, the disparity of the viewpoint of the processing result image with respect to the pixel of the captured image PL2, in which the object obj1 appears, is denoted by DP2, and the disparity of the viewpoint of the processing result image with respect to the pixel of the captured image PL5, in which the object obj1 appears, is denoted by DP5.

Note that the viewpoint of the processing result image is equal to the reference viewpoint of the captured image PL1 in FIG. 8 so that the disparity DP1 of the viewpoint of the processing result image with respect to the pixel of the captured image PL1, in which the object obj1 appears, is (0, 0).

As for the captured images PL1, PL2, and PL5, the captured images PL1, PL2, and PL5 are pixel-shifted according to the disparities DP1, DP2, and DP5, respectively, and the captured images PL1, P12, and PL5 after the pixel-shifting are added so that the processing result image focused on the object obj1 can be obtained.

In other words, by pixel-shifting the captured images PL1, PL2, and PL5 so as to cancel the disparities DP1, DP2, and DP5 (in the directions opposite to the disparities DP1, DP2, and DP5), respectively, so that the positions of the pixels in which the object obj1 appears coincide with each other in the captured images PL1, PL2, and PL5 after the pixel-shifting.

Therefore, by adding the captured images PL1, PL2, and PL5 after the pixel-shifting, the processing result image focused on the object obj1 can be obtained.

Note that the positions of the pixels in which the object obj2 at a position different from that of the object obj1 in the depth direction appears do not coincide with each other in the captured images PL1, PL2, and PL5 after the pixel-shifting. Therefore, the object obj2 appearing in the processing result image is blurred.

Furthermore, here, the viewpoint of the processing result image is the reference viewpoint and the disparity DP1 is (0, 0) as described above, it is substantially unnecessary to pixel-shift the captured image PL1.

In the light condensing processing of the light condensing processing unit 33, for example, as described above, the pixels of the viewpoint images of the plurality of viewpoints are pixel-shifted so as to cancel the disparity of the viewpoint (here, the reference viewpoint) of the processing target image with respect to the focusing target pixel in which the focusing target appears, and are added so that the image refocused on the focusing target is obtained as the processing result image.

<Disparity Conversion>

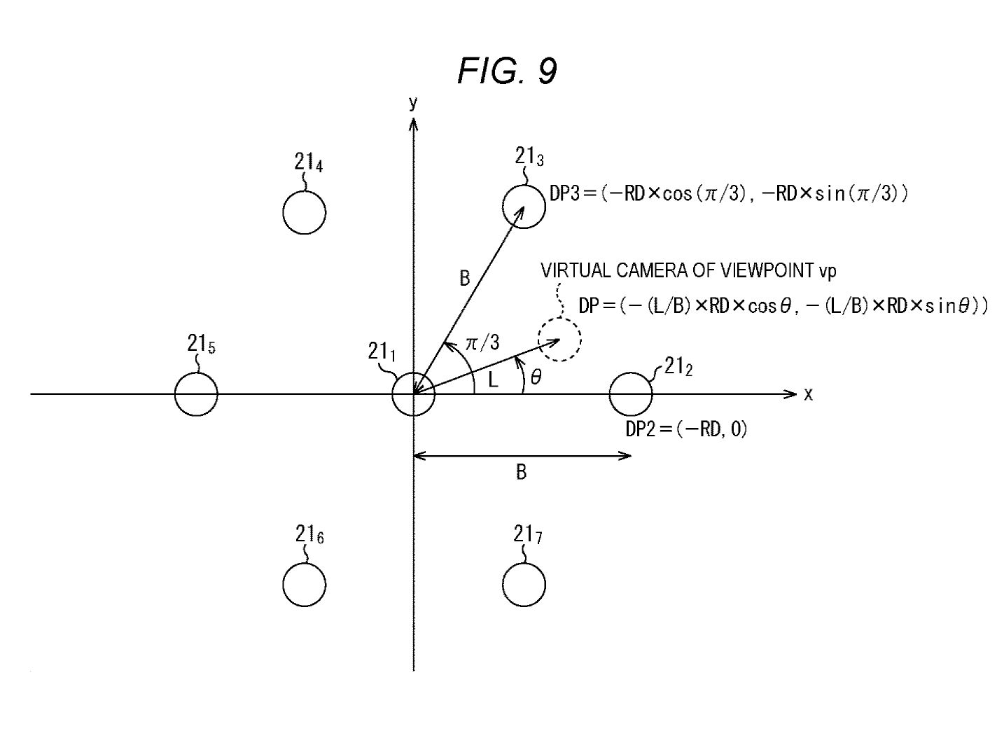

FIG. 9 is a diagram for explaining an example of the disparity conversion.

As described with FIG. 7, the registration disparity registered in the disparity map is equal to the x component of the disparity of the pixel of the reference image PL1 with respect to each pixel of the captured image PL5 of the viewpoint adjacent to the left of the reference image P1.

In the refocusing, it is necessary to pixel-shift the viewpoint images so as to cancel the disparity of the focusing target pixel.

Now paying attention to a certain viewpoint as an attention viewpoint, to pixel-shift the viewpoint image of the attention viewpoint in the refocusing, the disparity of the focusing target pixel of the processing result image with respect to the viewpoint image of the attention viewpoint, in other words, for example, the disparity of the focusing target pixel of the reference image PL1 of the reference viewpoint is required here.

The disparity of the focusing target pixel of the reference image PL1 with respect to the viewpoint image of the attention viewpoint can be obtained by taking into consideration the direction from the reference viewpoint (the viewpoint of the processing target pixel) to the attention viewpoint from the registration disparity of the focusing target pixel (the corresponding pixel of the reference image PL corresponding to the focusing target pixel of the processing result image) of the reference image PL1.

Now the direction from the reference viewpoint to the attention viewpoint is represented by a counterclockwise angle with the x axis being 0 [radian].

For example, the camera 21₂ is at a position apart in the +x direction by the reference baseline length B, and the direction from the reference viewpoint to the viewpoint of the camera 21₂ is 0 [radian]. In this case, (the vector as) the disparity DP2 of the focusing target pixel of the reference image PL1 with respect to the viewpoint image (the captured image PL2) of the viewpoint of the camera 21₂ can be obtained by (−RD, 0)=(−(B/B)×RD×cos 0, −(B/B)×RD×sin 0) by taking into consideration 0 [radian], which is the direction of the viewpoint of the camera 21₂, from the registration disparity RD of the focusing target pixel.

Furthermore, for example, the camera 21₃ is at a position apart in the π/3 direction by the reference b baseline length B, and the direction from the reference viewpoint to the viewpoint of the camera 21₂ is π/3 [radian]. In this case, the disparity DP3 of the focusing target pixel of the reference image PL1 with respect to the viewpoint image (the captured image PL3) of the viewpoint of the camera 21₃ can be obtained by (−RD×cos π/3), −RD×sin(π/3))=(−(B/B)×R×cos(π/3), −(B/B)×RD×sin(π/3)) by taking into consideration π/3 [radian], which is the direction of the viewpoint of the camera 21₃, from the registration disparity RD of the focusing target pixel.

Here, the interpolation images obtained by the interpolation unit 32 can be regarded as images captured by a virtual camera positioned at the viewpoints vp of the interpolation images. The viewpoint vp of this virtual camera is at a position apart from the reference viewpoint in an angle θ [radian] direction by a distance L. In this case, the disparity DP of the focusing target pixel of the reference image PL1 with respect to the viewpoint image (the image captured by the virtual camera) of the viewpoint vp can be obtained by (−(L/B)×RD×cos θ, −(L/B)×RD×sin θ) by taking into consideration the angle θ, which is the direction of the viewpoint vp, from the registration disparity RD of the focusing target pixel.

As described above, obtaining the disparity of the pixel of the reference image PL1 with respect to the viewpoint image of the attention viewpoint by taking into consideration the direction of the attention viewpoint from the registration disparity RD, in other words, converting the registration disparity RD into the disparity of the pixel of the reference image PL1 (the processing result image) with respect to the viewpoint image of the attention viewpoint is also referred to as disparity conversion.

In the refocusing, the disparity of the focusing target pixel of the reference image PL1 with respect to the viewpoint image of each viewpoint is obtained from the registration disparity RD of the focusing target pixel by the disparity conversion, and the viewpoint image of each viewpoint is pixel-shifted so as to cancel the disparity of the focusing target pixel.

In the refocusing, the viewpoint images are pixel-shifted so as to cancel the disparities of the focusing target pixels with respect to the viewpoint images, and a shift amount of this pixel-shifting is also referred to as a focusing shift amount.

Here, the viewpoint of the i-th viewpoint image among the viewpoint images of the plurality of viewpoints obtained by the interpolation unit 32 is also described as a viewpoint vp#i hereinafter. The focusing shift amount of the viewpoint image of the viewpoint vp#i is also described as a focusing shift amount DP#i.

The focusing shift amount DP#i of the viewpoint image of the viewpoint vp#i can be uniquely obtained from the registration disparity RD of the focusing target pixel by disparity conversion taking into consideration the direction from the reference viewpoint to the viewpoint vp#i.

Here, in the disparity conversion, (the vector as) the disparity (−(L/B)×RD×cos θ, −(L/B)×RD×sin θ) is obtained from the registration disparity RD as described above.

Therefore, the disparity conversion can be grasped as, for example, an operation of multiplying the registration disparity RD by both −(L/B)×cos θ and −(L/B)×sin θ, an operation of multiplying negative one times the registration disparity RD by both (I/B)×cos and (L/B)×sin θ, or the like.

Here, for example, the disparity conversion is grasped as an operation of multiplying negative one times the registration disparity R) by both (L/B)×cos θ and (L/B)×sin θ.

In this case, a target value of the disparity conversion, in other words, negative one times the registration disparity RD here is a reference value for obtaining the focusing shift amount of the viewpoint image of each viewpoint and is also referred to as a reference shift amount BV hereinafter.

Since the focusing shift amount is uniquely decided by the disparity conversion of the reference shift amount BV, according to the setting of the reference shift amount BV, a pixel-shift amount for pixel-shift shifting the pixel of the viewpoint image of each viewpoint is set substantially in the refocusing by the setting.

Note that, in a case where negative one times the registration disparity RD is employed as the reference shift amount BV as described above, the reference shift amount BV when the focusing target pixel is focused, in other words, negative one times the registration disparity RD of the focusing target pixel is equal to the x component of the disparity of the focusing target pixel with respect to the captured image PL2.

<Refocusing Mode>

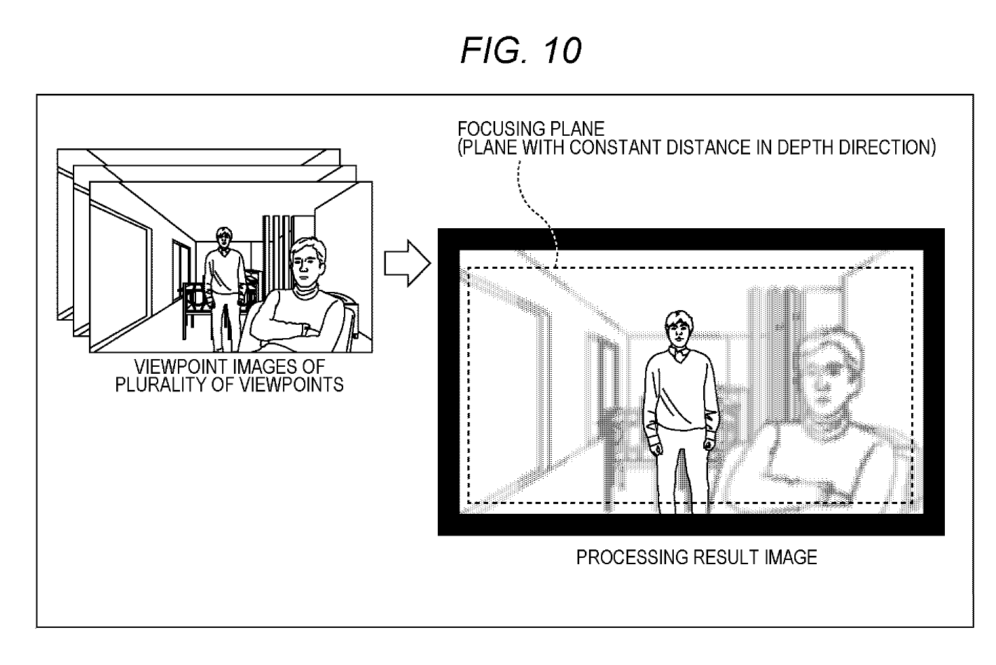

FIGS. 10, 11, and 12 are diagrams for explaining overviews of refocusing modes.

Examples of the refocusing by the light condensing processing performed by the light condensing processing unit 33 include a simple refocusing mode, a tilt refocusing mode, and a multifocal refocusing mode.

In the simple refocusing mode, each pixel value of the processing result image focused on focusing points with the same distance in the depth direction is obtained. In the tilt refocusing mode and the multifocal refocusing mode, each pixel value of the processing result image focused on a plurality of focusing points with different distances in the depth direction is obtained.

Since the reference shift amount BV can be set for each pixel of the processing result image in the refocusing by the light condensing processing performed by the light condensing processing unit 33, a wide variety of refocusing cant be realized such as a tilt refocusing mode and a multifocal refocusing mode in addition to the simple refocusing mode.

FIG. 10 is a diagram for explaining the overview of the simple refocusing mode.

The plane that is constituted by a group of focusing points (focused real space points in the real space) is now referred to as a focusing plane.

In the simple refocusing mode, with a plane having a constant (unchanging) distance in the depth direction in the real space as the focusing plane, a processing result image focused on a subject positioned (in the vicinity of the focusing plane) on the focusing plane is generated by using viewpoint images of a plurality of viewpoints.

In FIG. 10, one person appears at each of the front and middle of the viewpoint images of the plurality of viewpoints. Then, with a plane, which passes through the position of the middle person and has a constant distance in the depth direction, as the focusing plane, a processing result image focused on the subject on the focusing plane, in other words, for example, the middle person is obtained from the viewpoint images of the plurality of viewpoints.

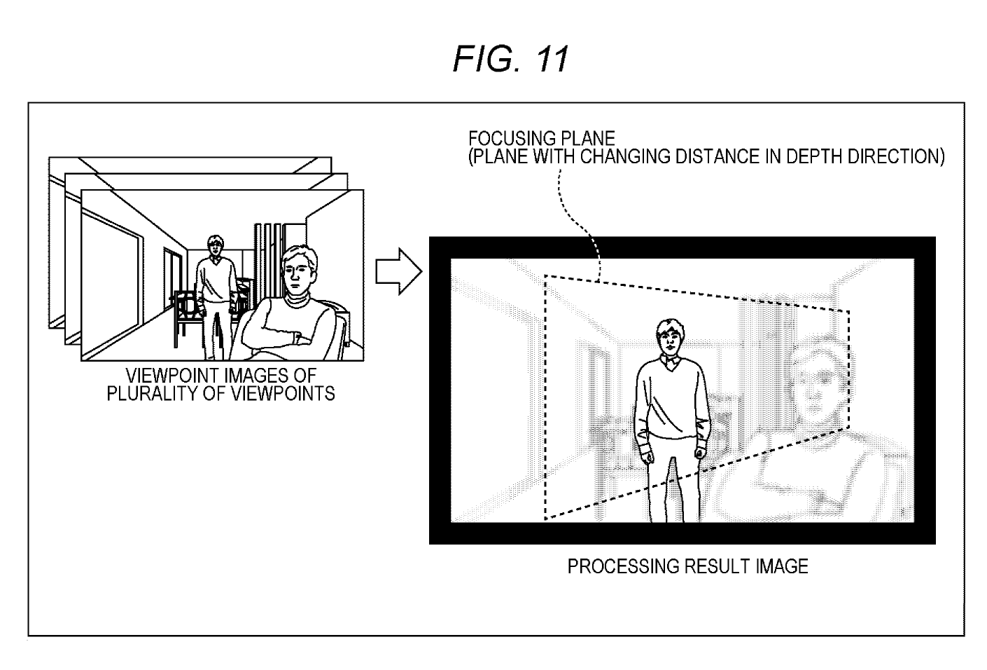

FIG. 11 is a diagram for explaining the overview of the tilt refocusing mode.

In the tilt refocusing mode, with a plane having a changing distance in the depth direction in the real space as the focusing plane, a processing result image focused on a subject positioned on the focusing plane is generated by using viewpoint images of a plurality of viewpoints.

According to the tilt refocusing mode, for example, it is possible to obtain a processing result image similar to an image obtained by performing so-called tilt image capturing with an actual camera.

In FIG. 11, with a plane, which passes through the position of a middle person appearing in the viewpoint images of the plurality of viewpoints as in the case in FIG. 10 and has an increasing distance in the depth direction toward the right side, as the focusing plane, a processing result image focused on the subject on the focusing plane is obtained.

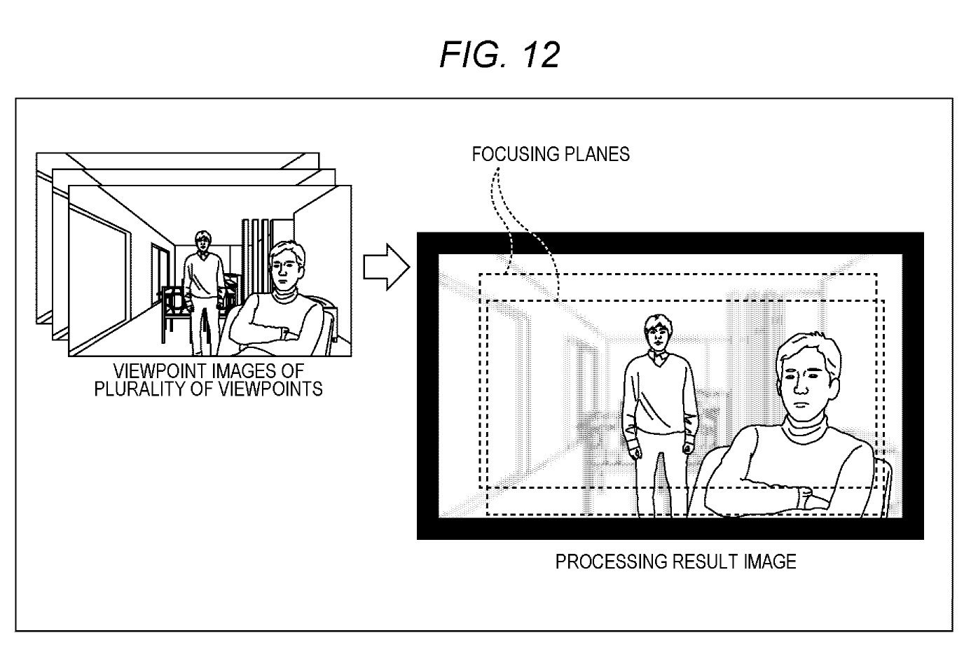

FIG. 12 is a diagram for explaining the overview of the multifocal refocusing mode.

In the multifocal refocusing mode, with a plurality of planes in the real space as the focusing planes, a processing result image focused on subjects positioned on the plurality of respective focusing planes is generated by using viewpoint images of a plurality of viewpoints.

According to the multifocal refocusing mode, it is possible to obtain a processing result image focused on a plurality of subjects at different distances in the depth direction.

In FIG. 12, with both of two planes, a plane passing through the position of a front person and a plane passing through the position of a middle person in which both persons appear in viewpoint images of a plurality of viewpoints as in the case in FIG. 10, as the focusing planes, a processing result image focused on the subjects positioned on the two respective focusing planes, in other words, for example, on both of the front person and the middle person is obtained.

In the simple refocusing mode, the tilt refocusing mode, and the multifocal refocusing mode, for example, the reference image PL1 or the like among the viewpoint images of the plurality of viewpoints is displayed on the display apparatus 13, and the reference image PL1 displayed on the display apparatus 13 is manipulated by a user so that the focusing plane can be set according to the manipulation of the user.

In other words, in the simple refocusing mode, for example, in a case where the user designates one position on the reference image PL1, one plane, which passes through a spatial point appearing in the pixel at the one position on the reference image PL1 and has an unchanging distance in the depth direction, can be set as the focusing plane.

In the tilt refocusing mode, for example, in a case where the user designates two positions on the reference image PL1, a plane, which passes through two spatial points appearing in two pixels at the two positions on the reference image PL1 and is parallel to the horizontal direction (a plane parallel to the x axis) or is parallel to the vertical direction (a plane parallel to the y axis), can be set as the focusing plane.

Furthermore, in the tilt refocusing mode, for example, in a case where the user designates three positions on the reference image PL1, a plane, which passes through three spatial points appearing in three pixels at the three positions on the reference image PL1, can be set as the focusing plane.

In the multifocal refocusing mode, for example, in a case where the user designates a plurality of positions on the reference image PL1, a plurality of planes, which pass through respective spatial points appearing in the respective pixels at the plurality of positions on the reference image PL1 and have unchanging distances in the depth direction, can be set as the focusing planes.

Note that a plane other than a flat plane, in other words, for example, a curved plane can be employed as the focusing planes in the tilt refocusing mode and the multifocal refocusing mode.

Furthermore, the refocusing mode can be set, for example, according to the manipulation of the user.

For example, it is possible to set the refocusing mode to the mode selected by the user according to the manipulation of the user selecting the simple refocusing mode, the tilt refocusing mode, and the multifocal refocusing mode.

Furthermore, for example, the refocusing mode can be set according to the designation of the position on the reference image PL1 by the user.

For example, in a case where the user designates one position on the reference image PL1, it is possible to set the refocusing mode to the simple refocusing mode. In this case, one plane, which passes through a spatial point appearing in the pixel at the one position, which is designated by the user, on the reference image PL1 and has an unchanging distance in the depth direction, can be set as the focusing plane.

Furthermore, for example, in a case where the user designates a plurality of positions on the reference image PL1, it is possible to set the refocusing mode to the tilt refocusing mode or the multifocal refocusing mode. In this case, in the tilt refocusing mode, one plane, which passes through a plurality of spatial points appearing in a plurality of pixels at the plurality of positions, which are designated by the user, on the reference image PL1, can be set as the focusing plane. In the multifocal refocusing mode, a plurality of planes, which pass through respective spatial points appearing in the respective pixels at the plurality of positions, which are designated by the user, on the reference image PL1, can be set as the focusing planes.

In a case where the user designates a plurality of positions on the reference image PL1, which of the tilt refocusing mode or the multifocal refocusing mode is set as the refocusing mode can be set in advance, for example, according to the manipulation of the user, or the like.

Furthermore, in a case where image recognition for detecting a subject appearing in the reference image PL1 is performed as the image processing on the reference image PL1 and a plurality of spatial points appearing in a plurality of pixels at a plurality of positions, which are designated by the user, on the reference image PL1 are points of the same subject, the refocusing mode can be set to the tilt refocusing mode. In a case where the plurality of spatial points are points of different subjects, the refocusing mode can be set to the multifocal refocusing mode.

In this case, for example, when the user designates positions of a plurality of pixels in which a subject (e.g., a carpet, a tablecloth, or the like) extending in the depth direction appears, the refocusing mode is set to the tilt refocusing mode, and a processing result image focused on the entire subject extending in the depth direction is generated.

Furthermore, for example, when the user designates the positions of a plurality of pixels in which different subjects appear, the refocusing mode is set to the multifocal refocusing mode, and a processing result image focused on both of the different subjects designated by the user is generated.

<Simple Refocusing Mode>

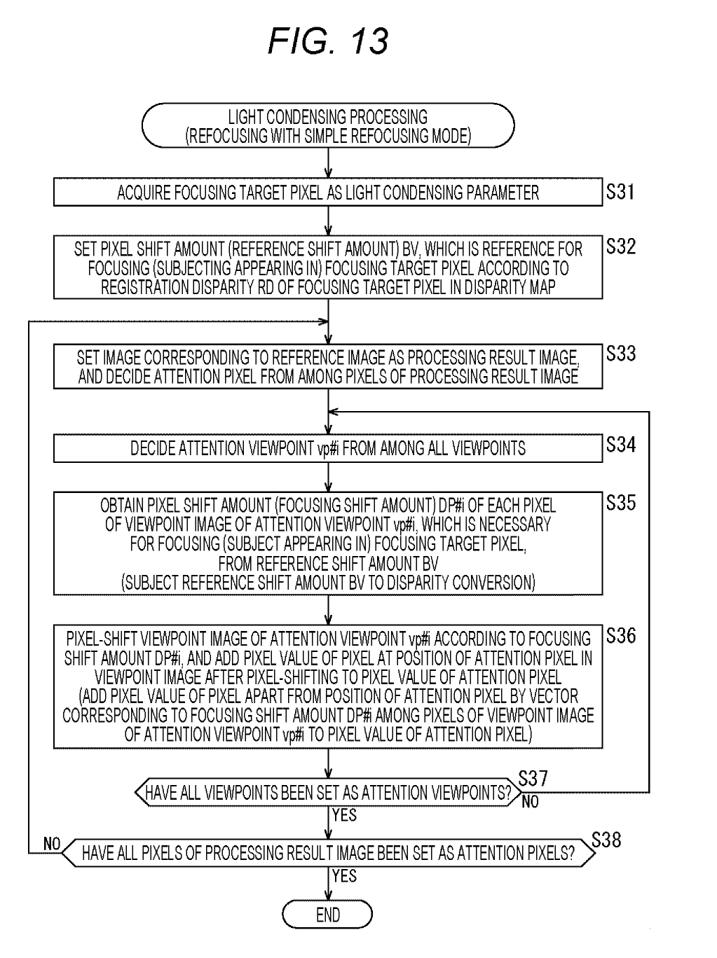

FIG. 13 is a flowchart for explaining an example of the light condensing processing performed by the light condensing processing unit 33 in a case where the refocusing mode is set to the simple refocusing mode.

In step S31, the light condensing processing unit 33 acquires (the information on) the focusing target pixel as the light condensing parameter from the parameter setting unit 34, and the processing proceeds to step S32.

In other words, for example, the reference image PL1 or the like among the capturing images PL1 to PL7 captured by the cameras 21₁ to 21₇ is displayed on the display apparatus 13. When the user designates one position on the reference image PL1, the parameter setting unit 34 sets the pixel at the position designated by the user as the focusing target pixel and supplies the light condensing processing unit 33 with (the information representing) the focusing target pixel as the light condensing parameter.

In step S31, the light condensing processing unit 33 acquires the focusing target pixel supplied from the parameter setting unit 34 as described above.

In step S32, the light condensing processing unit 33 acquires the registration disparity RD of the focusing target pixel registered in the disparity map from the disparity information generation unit 31. Then, the light condensing processing unit 33 sets the reference shift amount BV according to the registration disparity RD of the focusing target pixel, in other words, for example, sets negative one times the registration disparity RD of the focusing target pixel as the reference shift amount BV, and the processing proceeds from step S32 to step S33.

In step S33, the light condensing processing unit 33 sets, as the processing result image, for example, the image corresponding to the reference image, which is one image among the viewpoint images of the plurality of viewpoints from the interpolation unit 32, in other words, the image, which is viewed from the viewpoint of the reference image, has the same size as the reference image, and is the image with the pixel value of 0 as an initial value. Moreover, the light condensing processing unit 33 decides, as the attention pixel, one pixel among the pixels that have not yet been decided as the attention pixels from among the pixels of the processing result image, and the processing proceeds from step S33 to step S34.

In step S34, the light condensing processing unit 33 decides, as the attention viewpoint vp#i, one viewpoint vp#i that has not yet been decided as the attention viewpoint (for the attention pixel) among the viewpoints of the viewpoint images from the interpolation unit 32, and the processing proceeds to step S35.

In step S35, the light condensing processing unit 33 obtains the focusing shift amount DP#i of each pixel of the viewpoint image of the attention viewpoint vp#i, which is necessary for focusing the focusing target pixel (focusing on the subject appearing in the focusing target pixel), from the reference shift amount BV.

In other words, the light condensing processing unit 33 subjects the reference shift amount BV to the disparity conversion in consideration of the direction from the reference viewpoint to the attention viewpoint vp#i and acquires the value (vector) obtained as a result of the disparity conversion as the focusing shift amount DP#i of each pixel of the viewpoint image of the attention viewpoint vp#i.

Thereafter, the processing proceeds from step S35 to step S36, and the light condensing processing unit 33 pixel-shifts each pixel of the viewpoint image of the attention viewpoint vp#i according to the focusing shift amount DP#i and adds the pixel value of the pixel at the position of the attention pixel in the viewpoint image after the pixel-shifting to the pixel value of the attention pixel.

In other words, the light condensing processing unit 33 adds, to the pixel value of the attention pixel, the pixel value of the pixel apart from the position of the attention pixel by a vector (here, for example, negative one times the focusing shift amount DP#i) corresponding to the focusing shift amount DP#i among the pixels of the viewpoint image of the attention viewpoint vp#i.

Then, the processing proceeds from step S36 to step S37, and the light condensing processing unit 33 determines whether or not all the viewpoints of the viewpoint images from the interpolation unit 32 have been set as the attention viewpoints.

In a case where it has been determined in step S37 that not all the viewpoints of the viewpoint images from the interpolation unit 32 have been yet set as the attention viewpoints, the processing returns to step S34, and the similar processing is repeated thereafter.

Furthermore, in a case where it has been determined in step S37 that all the viewpoints of the viewpoint images from the interpolation unit 32 have been set as the attention viewpoints, the processing proceeds to step 338.

In step S38, the light condensing processing unit 33 determines whether or not all the pixels of the processing result image have been set as the attention pixels.

In a case where it has been determined in step S38 that not all the pixels of the processing result image have been yet set as the attention pixels, the processing returns to step S33, the light condensing processing unit 33 newly decides, as the attention pixel, one pixel among the pixels that have not yet been decided as the attention pixels from among the pixels of the processing result image as described above, and the similar processing is repeated thereafter.

Furthermore, in a case where it has been determined in step S38 that all the pixels of the processing result image have been set as the attention pixels, the light condensing processing unit 33 outputs the processing result image and ends the light condensing processing.

Note that, in the simple refocusing mode, the reference shift amount BV is set according to the registration disparity RD of the focusing target pixel and does not change depending on the attention pixel or the attention viewpoint vp#i. Therefore, in the simple refocusing mode, the reference shift amount BV is set regardless of the attention pixel and the attention viewpoint vp#i.

Furthermore, the focusing shift amount DP#i changes depending on the attention viewpoint vp#i and the reference shift amount By. However, in the simple refocusing mode, the reference shift amount BV does not change depending on the attention pixel or the attention viewpoint vp#i as described above. Therefore, the focusing shift amount DP#i changes depending on the attention viewpoint vp#i, but does not change depending on the attention pixel. In other words, the focusing shift amount DP#i has the same value for each pixel of the viewpoint image of one viewpoint regardless of the attention pixel.

In FIG. 13, the processing in step S35 of obtaining the focusing shift amount DP#i constitutes a loop of repeatedly calculating the focusing shift amount DP#i for the same viewpoint vp#i with respect to different attention pixels (a loop of steps S33 to S38). However, as described above, the focusing shift amount DP#i has the same value for each pixel of the viewpoint image of one viewpoint regardless of the attention pixel.

Therefore, in FIG. 13, the processing in step S35 of obtaining the focusing shift amount DP#i should be performed only once for one viewpoint.

In the simple refocusing mode, since the plane having a constant distance in the depth direction is the focusing plane as described with FIG. 10, the reference shift amount BV of the viewpoint image necessary for focusing the focusing target pixel becomes one value so as to cancel the disparity of the focusing target pixel in which the spatial point on the focusing plane having a constant distance in the depth direction appears, in other words, of the focusing target pixel with the disparity of the value corresponding to the distance to the focusing plane.

Therefore, in the simple refocusing mode, since the reference shift amount BV does not depend on the pixel (attention pixel) of the processing result image or the viewpoint (attention viewpoint) of the viewpoint image to which the pixel value is added, it is unnecessary to set the reference shift amount BV for each pixel of the processing result image or for each viewpoint of the viewpoint images (even if the reference shift amount BV is set for each pixel of the processing result image and for each viewpoint of the viewpoint images, the reference shift amount BV is set to the same value so that the reference shift amount BV is not substantially set for each pixel of the processing result image or for each viewpoint of the viewpoint images).

Note that the pixel-shifting of the pixels of the viewpoint images and the addition are performed for each pixel of the processing result image in FIG. 13, but the pixel-shifting of the pixels of the viewpoint images and the addition can be performed in the light condensing processing for each subpixel obtained by minutely dividing the pixels of the processing result image, in addition to for each pixel of the processing result image.

Furthermore, in the light condensing processing in FIG. 13, the loop of the attention pixels (the loop of steps S33 to S38) is outside, and the loop of the attention viewpoints (the loop of steps S34 to S37) is inside, but it is possible to make the loop of the attention viewpoints an outside loop as well as the loop of the attention pixels an inside loop.

These points are similarly applied to the light condensing processing of the tilt refocusing mode and the multifocal refocusing mode as described later.

<Tilt Refocusing Mode>

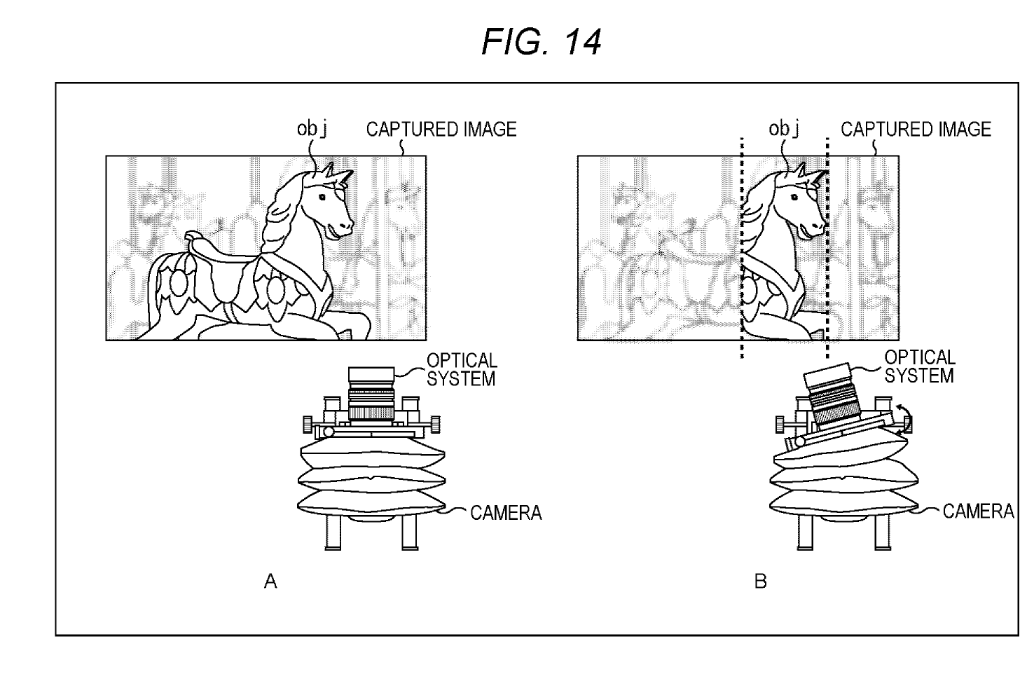

FIG. 14 is a view for explaining tilt image capturing with an actual camera.

A of FIG. 14 shows how normal image capturing, in other words, image capturing in a state where the optical axis of an optical system such as a lens of a camera is orthogonal to (a light receiving surface) of an image sensor and film (not shown) is done.

In A of FIG. 14, as for an object obj having a substantially transverse horse shape, substantially the entire object obj is positioned substantially equidistant from the image capturing position so that, in the normal image capturing, a capturing image focused on substantially the entire object obj is being captured.

B of FIG. 14 shows how the tilt image capturing, in other words, for example, image capturing in a state where the optical axis of the optical system of the camera is slightly tilted from the state of being orthogonal to the image sensor and the film (not shown) is done.

In B of FIG. 14, the optical axis of the optical system of the camera is slightly tilted in the left direction compared with the case of the normal image capturing. Therefore, as for an object obj having a substantially transverse horse shape, the head side portion is focused rather than the back of the horse, and a capturing image in which the butt side portion is more blurred than the back of the horse is being captured.

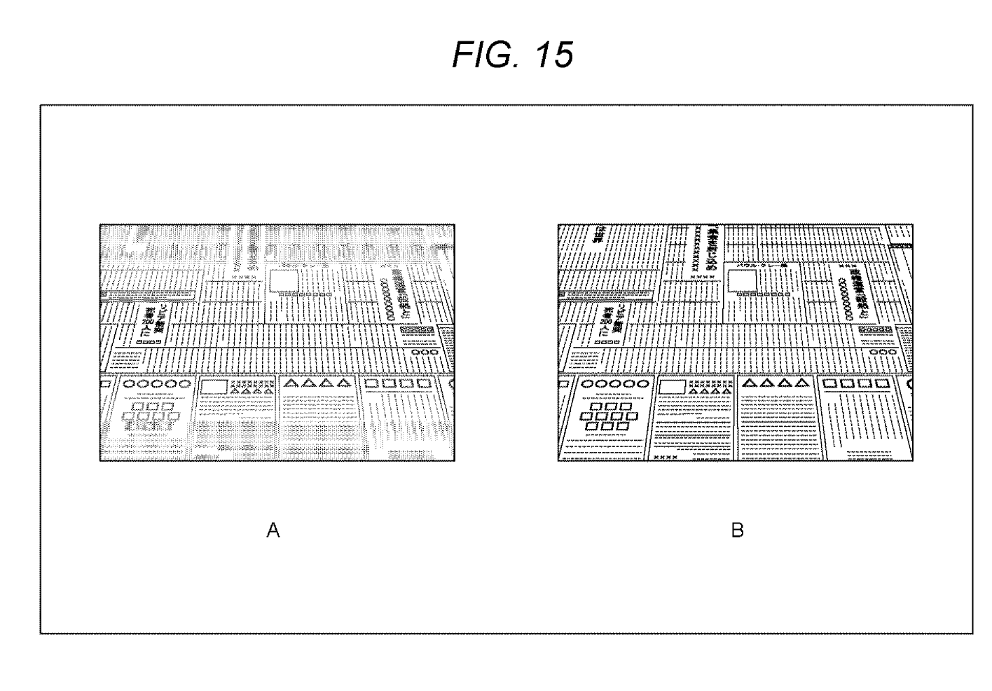

FIG. 15 is a view showing an example of capturing images captured by the normal image capturing and the tilt image capturing with an actual camera.

In FIG. 15, for example, images of a newspaper (paper) spread on a desk are being captured.

A of FIG. 15 shows a capturing image of the newspaper spread on the desk captured by the normal image capturing.

In A of FIG. 15, the middle of the newspaper is focused, and the front side and the far side of the newspaper are blurred.

B of FIG. 15 shows a capturing image of the newspaper spread on the desk captured by the tilt image capturing.

As for the captured image in B of FIG. 15, the tilt image capturing is performed by tilting the optical axis of the optical system of the camera slightly downward as compared with the case of the normal image capturing. Therefore, the front side to the far side of the newspaper spread on the desk are focused.

In the tilt refocusing mode, the refocusing is performed to obtain the captured image obtained by the tilt image capturing as described above as the processing result image.

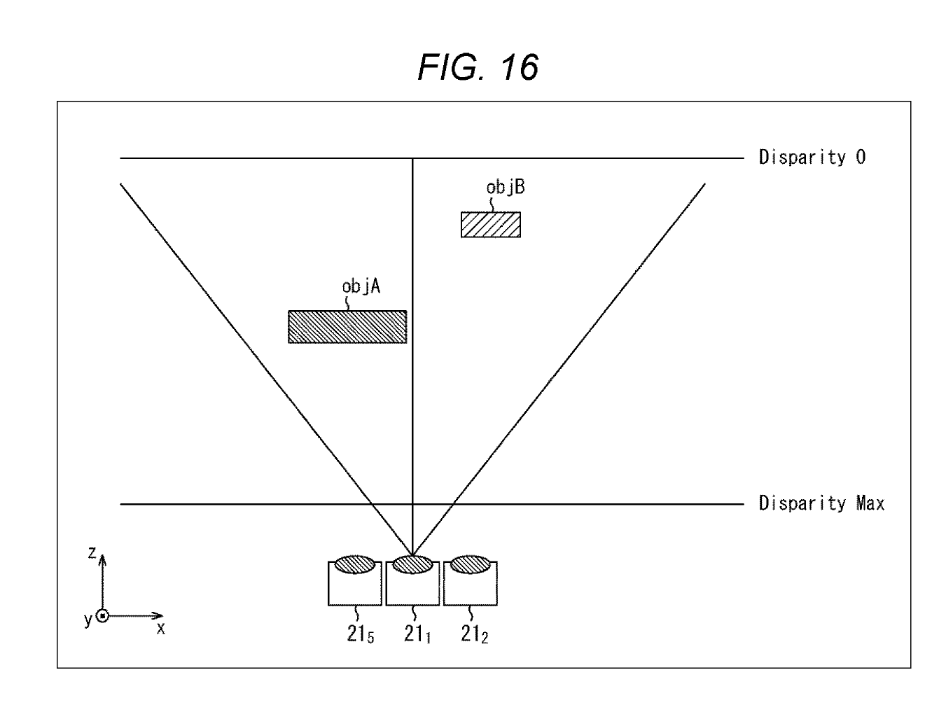

FIG. 16 is a plan view showing an example of an image capturing situation of the image capturing by the image capturing apparatus 11.

In FIG. 16, an object objA is arranged on the front left side, an object objB is arranged on the far right side, and the capturing images PL1 to PL7 are being captured by the cameras 21₁ to 21₇ so that these objects objA and objB appear.

(The magnitude of) the disparity of the pixel in which the object objA on the front side appears becomes a large value, and the disparity of the pixel in which the object objB on the far side appears becomes a small value.

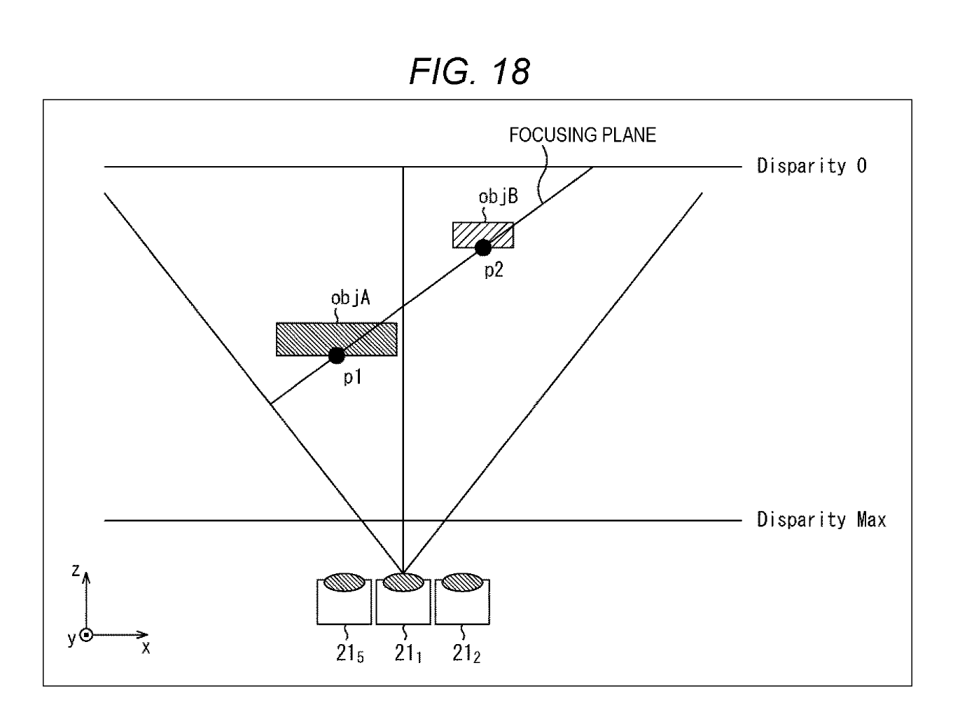

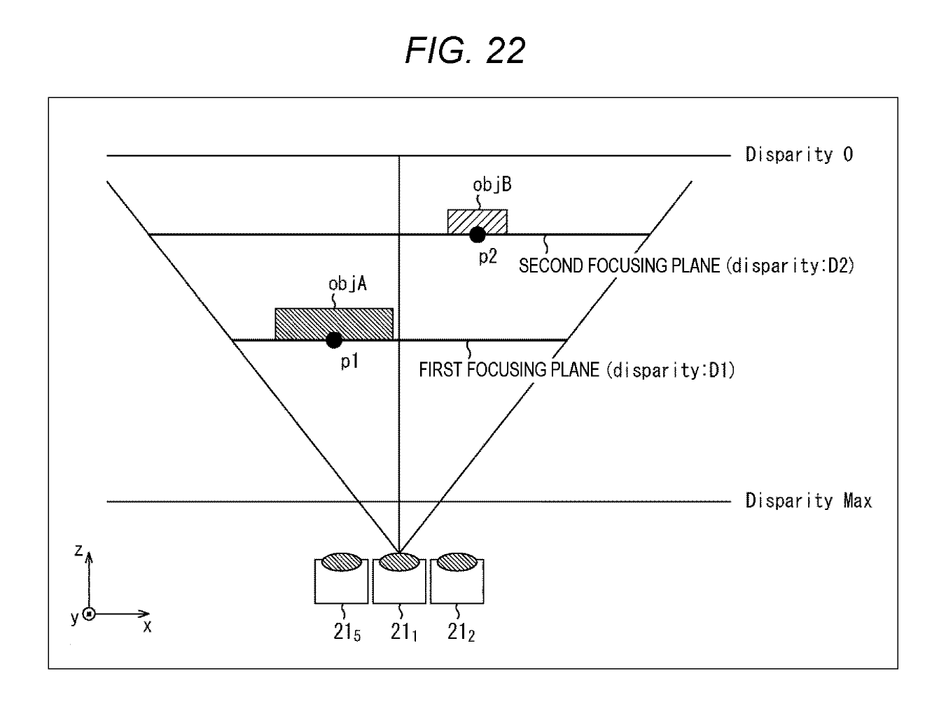

Note that only the reference camera 21₁ and the cameras 21₂ and 21₂ adjacent to the left and right thereof among the camera 21₁ to 21₇ are shown in FIG. 16 (the same applies to FIGS. 18 and 22 as described later).

Furthermore, as the three-dimensional coordinate system hereinafter, a coordinate system, in which a direction from the left to the right (horizontal direction) is the x axis, the direction from the down to the up (vertical direction) is the y axis and the direction from the front to the far side of the camera 21ᵢ is the z axis, is considered.

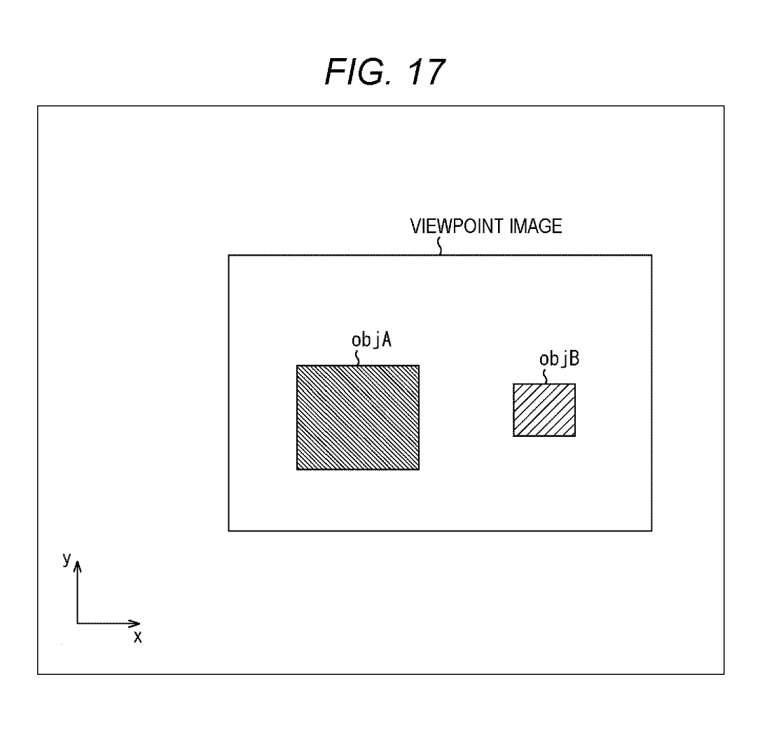

FIG. 17 is a plan view showing an example of the viewpoint image obtained from the capturing images PL#i captured in the image capturing situation in FIG. 16.

In the viewpoint image, the object objA at the front appears on the left side, and the object objB at the far side appears on the right side.

FIG. 18 is a plan view for explaining an example of setting of the focusing plane in the tilt refocusing mode.

In other words, FIG. 18 shows an image capturing situation as in FIG. 16.

For example, on the display apparatus 13, for example, the reference image PL1 among the capturing images PL#i captured in the image capturing situation in FIG. 16 is displayed. Then, when the user designates two positions on the reference image PL1 displayed on the display apparatus 13, the light condensing processing unit 33 obtains (the positions of) the spatial points appearing in the pixels at the positions, which are designated by the user, on the reference image PL1 by using the positions of the pixels and the registration disparity RD of the disparity map.

Now, the user designates two positions, the position of the pixel in which the object objA appears and the position of the pixel in which the object objB appears, and a spatial point p1 on the object objA appearing in the pixel at one position designated by the user and a spatial point p2 on the object objB appearing in the pixel at the other position designated by the user are obtained.

In the tilt refocusing mode, for example, the light condensing processing unit 33 sets, as the focusing plane, the plane passing through the two spatial points (hereinafter, also referred to as designated spatial points) p1 and p2 appearing in the two pixels at the two positions designated by the user.

Here, as a plane passing through the two designated spatial points p1 and p2, there are countless planes including a straight line passing through the two designated spatial points p1 and p2.

For the two designated spatial points p1 and p2, the light condensing processing unit 33 sets, as the focusing plane, one plane among the countless planes including a straight line passing through the two designated spatial points p1 and p2.

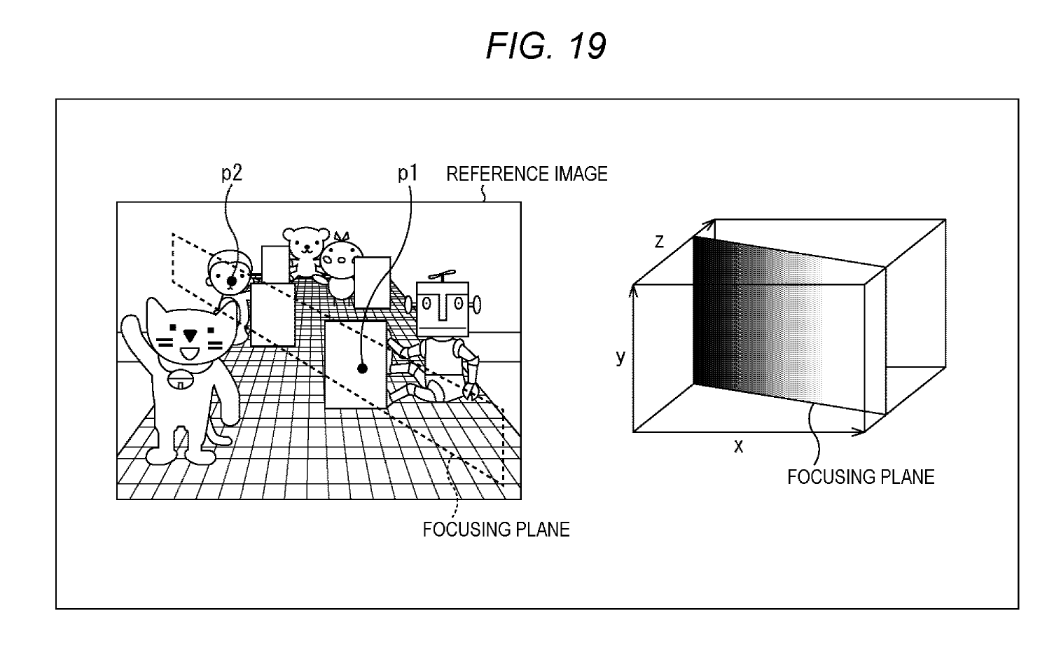

FIG. 19 is a diagram for explaining a first setting method of setting, as the focusing plane, one plane among the countless planes including a straight line passing through the two designated spatial points p1 and p2.

In other words, FIG. 19 shows the reference image and the focusing plane set by the first setting method using the designated spatial points p1 and p2 corresponding to the two positions designated by the user on the reference image.

In the first setting method, a plane parallel to the y axis (vertical direction) among the countless planes including a straight line passing through the two designated spatial points p1 and p2 is set as the focusing plane.

In this case, since the focusing plane is a plane perpendicular to the xz plane, a focusing distance, which is the distance from the virtual lens (the virtual lens with the cameras 21₁ to 21₇ as the synthetic apertures) to the focusing plane, changes only by the x coordinate of the pixel of the processing result image and does not change by the y coordinate.

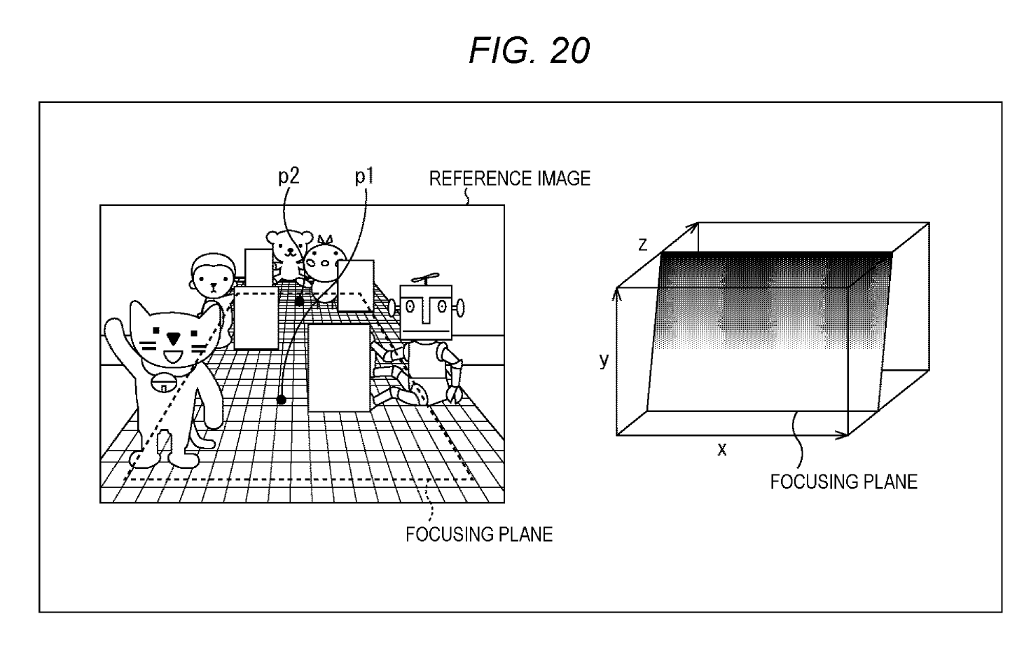

FIG. 20 is a diagram for explaining a second setting method of setting, as the focusing plane, one plane among the countless planes including a straight line passing through the two designated spatial points p1 and p2.

In other words, FIG. 20 shows the reference image and the focusing plane set by the second setting method using the designated spatial points p1 and p2 corresponding to the two positions designated by the user on the reference image.

In the second setting method, a plane parallel to the x axis (horizontal direction) among the countless planes including a straight line passing through the two designated spatial points p1 and p2 is set as the focusing plane.

In this case, since the focusing plane is a plane perpendicular to the yz plane, the focusing distance from the virtual lens to the focusing plane changes only by the y coordinate of the pixel of the processing result image and does not change by the x coordinate.

Note that shades of the focusing planes represent the magnitude of the disparity in FIGS. 19 and 20. In other words, the darker (black) portion represents that the magnitude of disparity is small.

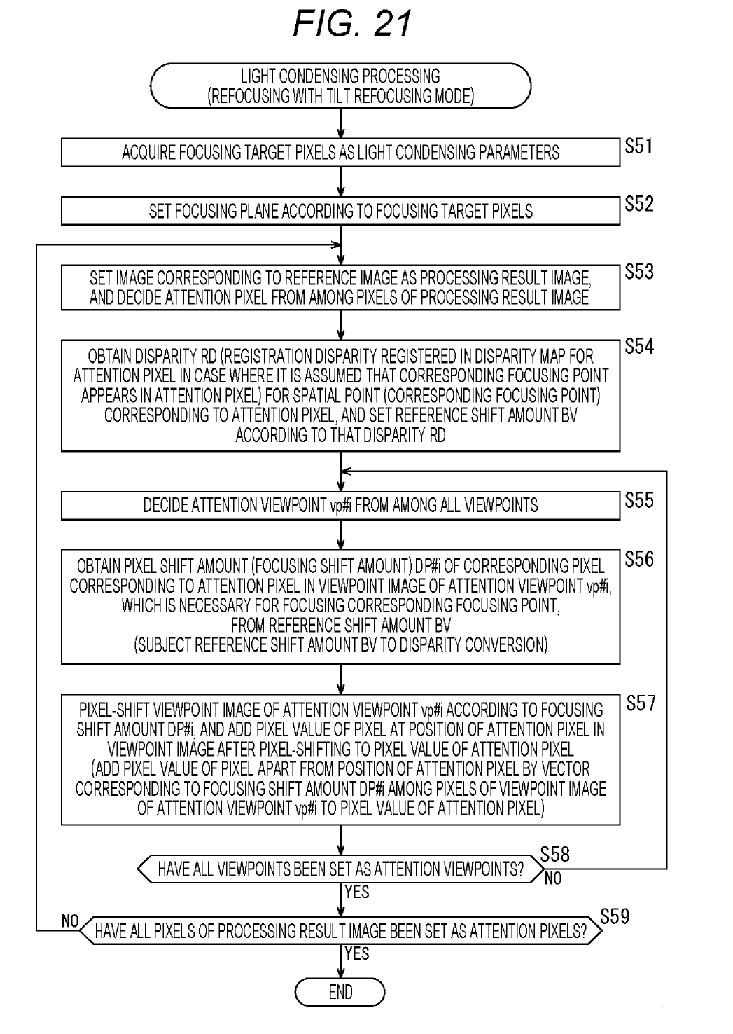

FIG. 21 is a flowchart for explaining an example of the light condensing processing performed by the light condensing processing unit 33 in a case where the refocusing mode is set to the tilt refocusing mode.

In step S51, the light condensing processing unit 33 acquires (the information on) the focusing target pixels as the light condensing parameters from the parameter setting unit 34, and the processing proceeds to step S52.

In other words, for example, the reference image PL1 or the like among the capturing images PL1 to PL7 captured by the cameras 21₁ to 21₇ is displayed on the display apparatus 13. When the user designates two or three positions on the reference image PL1, the parameter setting unit 34 sets the pixels at the positions designated by the user as the focusing target pixels and supplies the light condensing processing unit 33 with (the information representing) the focusing target pixels as the light condensing parameters.

In the tilt refocusing mode, the user can designate two or three positions on the reference image PL1, and two pixels or three pixels are also set as the focusing target pixels.

In step S51, the light condensing processing unit 33 acquires the focusing target pixels of two pixels or three pixels supplied from the parameter setting unit 34 as described above.

In step S52, the light condensing processing unit 33 sets, as the focusing plane, a plane passing through two or three spatial points (designated spatial points) appearing in the focusing target pixels of two pixels or three pixels according to the focusing target pixels of the two pixels or three pixels acquired from the parameter setting unit 34.

In other words, the light condensing processing unit 33 obtains (the positions (x, y, z)) of the designated spatial points appearing in the focusing target pixels from the parameter setting unit 34 by using the positions (x, y) of the focusing target pixels and the registration disparity RD of the disparity map from the disparity information generation unit 31. Then, the light condensing processing unit 33 obtains the plane passing through two or three designated spatial points appearing in the focusing target pixels of two pixels or three pixels and sets the plane as the focusing plane.

Thereafter, the processing proceeds from step S52 to step S53, and the light condensing processing unit 33 sets, for example, the image corresponding to the reference image as the processing result image as in step S33 in FIG. 13. Moreover, the light condensing processing unit 33 decides, as the attention pixel, one pixel among the pixels that have not yet been decided as the attention pixels from among the pixels of the processing result image, and the processing proceeds from step S53 to step S54.

In step S54, the light condensing processing unit 33 sets the reference shift amount BV according to (the position of) the attention pixel and the focusing plane, and the processing proceeds to step S55.

Specifically, the light condensing processing unit 33 obtains a corresponding focusing point on the focusing plane, which is a spatial point corresponding to the attention pixel. In other words, the light condensing processing unit 33 obtains a point (focusing point) on the focusing plane, which would appear in the attention pixel if an image of the focusing plane were captured from the reference viewpoint (the viewpoint of the processing result image), as the corresponding focusing point corresponding to the attention pixel.

Moreover, the light condensing processing unit 33 obtains the magnitude RD of the disparity of (the attention pixel in which the corresponding focusing point appears) the corresponding focusing point, in other words, for example, the registration disparity RD which will be registered in the disparity map for the attention pixel in a case where it is assumed that the corresponding focusing point appears in the attention pixel. Then, according to the magnitude RD of the disparity of the corresponding focusing point, the light condensing processing unit 33 sets, as the reference shift amount BV, for example, negative one times the magnitude RD of the disparity of the target focusing point.

In step S55, the light condensing processing unit 33 decides, as the attention viewpoint vp#i, one viewpoint vp#i that has not yet been decided as the attention viewpoint among the viewpoints of the viewpoint images from the interpolation unit 32, and the processing proceeds to step S56.

In step S56, the light condensing processing unit 33 obtains the focusing shift amount DP#i of the corresponding pixel corresponding to the attention pixel in the viewpoint image of the attention viewpoint vp#i, which is necessary for focusing the attention pixel (focusing on the corresponding focusing point appearing in the attention pixel), from the reference shift amount BV.

In other words, the light condensing processing unit 33 subjects the reference shift amount BV to the disparity conversion by using the direction from the reference viewpoint to the attention viewpoint vp#i and acquires the value obtained as a result of the disparity conversion as the focusing shift amount DP#i of the corresponding pixel (the pixel in which the corresponding focusing point appears in the viewpoint image of the attention viewpoint vp#i if the focusing plane is present as a subject) corresponding to the attention pixel in the viewpoint image of the attention viewpoint vp#i.

Thereafter, the processing proceeds from step S56 to step S57, and the light condensing processing unit 33 pixel-shifts each pixel of the viewpoint image of the attention viewpoint vp#i according to the focusing shift amount DP# i and adds the pixel value of the pixel at the position of the attention pixel in the viewpoint image after the pixel-shifting to the pixel value of the attention pixel.

In other words, the light condensing processing unit 33 adds, to the pixel value of the attention pixel, the pixel value of the pixel apart from the position of the attention pixel by a vector (here, for example, negative one times the focusing shift amount DP#i) corresponding to the focusing shift amount DP#i among the pixels of the viewpoint image of the attention viewpoint vp#i.

Then, the processing proceeds from step S57 to step S58, and the light condensing processing unit 33 determines whether or not all the viewpoints of the viewpoint images from the interpolation unit 32 have been set as the attention viewpoints.

In a case where it has been determined in step S58 that not all the viewpoints of the viewpoint images from the interpolation unit 32 have been yet set as the attention viewpoints, the processing returns to step S55, and the similar processing is repeated thereafter.

Furthermore, in a case where it has been determined in step S58 that all the viewpoints of the viewpoint images from the interpolation unit 32 have been set as the attention viewpoints, the processing proceeds to step 359.

In step S59, the light condensing processing unit 33 determines whether or not all the pixels of the processing result image have been set as the attention pixels.

In a case where it has been determined in step S59 that not all the pixels of the processing result image have been yet set as the attention pixels, the processing returns to step S53, the light condensing processing unit 33 newly decides, as the attention pixel, one pixel among the pixels that have not yet been decided as the attention pixels from among the pixels of the processing result image as described above, and the similar processing is repeated thereafter.

Furthermore, in a case where it has been determined in step S59 that all the pixels of the processing result image have been set as the attention pixels, the light condensing processing unit 33 outputs the processing result image and ends the light condensing processing.

Note that, in the tilt refocusing mode, the reference shift amount BV is set according to (the magnitude of) the disparity RD of the corresponding focusing point, which is the focusing point on the focusing plane which would appear in the attention pixel if the image of the focusing plane were captured.

Furthermore, the distance in the depth direction of the focusing plane set in the tilt refocusing mode can change depending on (the position (x, y) of) the attention pixel.

Therefore, in the tilt refocusing mode, the reference shift amount BV needs to be set for each attention pixel.

Conversely, by setting the reference shift amount BV for each attention pixel, it is possible to perform refocusing for focusing on the focusing plane in the tilt refocusing mode in which the distance in the depth direction can change depending on the attention pixel.

<Multifocal Refocusing Mode>

FIG. 22 is a plan view for explaining an example of setting of the focusing planes in the multifocal refocusing mode.

In other words, FIG. 22 shows an image capturing situation as in FIG. 16, and a viewpoint image similar to that in the case shown in FIG. 17 can be obtained from the capturing images PL#i captured in this image capturing situation.

For example, on the display apparatus 13, for example, the reference image PL1 among the capturing images PL#i captured in the image capturing situation in FIG. 22 is displayed. Then, when the user designates a plurality of positions, for example, two positions on the reference image PL1 displayed on the display apparatus 13, the light condensing processing unit 33 obtains (the positions of) the spatial points appearing in the pixels at the positions, which are designated by the user, on the reference image PL1 by using the positions of the pixels and the registration disparity RD of the disparity map.

Now, the user designates two positions, the position of the pixel in which the object objA appears and the position of the pixel in which the object objB appears, and a spatial point p1 on the object objA appearing in the pixel at one position designated by the user and a spatial point p2 on the object objB appearing in the pixel at the other position designated by the user are obtained.

In the multifocal refocusing mode, for example, the light condensing processing unit 33 sets, as the focusing planes, two planes which pass through the two respective spatial points (designated spatial points) p1 and p2 appearing in the two pixels at the two positions designated by the user and are planes perpendicular to the z axis (planes parallel to the xy plane).

Now, the focusing plane passing through the designated spatial point p1 is referred to as a first focusing plane, and the focusing plane passing through the designated spatial point p2 is referred to as a second focusing plane.

In FIG. 22, since the first focusing plane and the second focusing plane are planes perpendicular to the z axis, the distances in the depth direction do not change. In other words, as for the first focusing plane, the disparity of (the pixels of two different viewpoints in which the focusing points appear) each focusing point of the first focusing plane has the same value. As for the second focusing plane, the disparity of each focusing point of the second focusing plane has also the same value.

Furthermore, in FIG. 22, since the designated spatial point p1 is the front spatial point and the designated spatial point p2 is the far side spatial point, the first focusing plane and the second focusing plane have different distances in the depth direction. In other words, (the magnitude of) the disparity D1 of (each focusing point of) the first focusing plane is large, and (the magnitude of) the disparity D2 of the second focusing plane becomes small.

In the multifocal refocusing mode, one focusing plane of the first focusing plane or the second focusing planes is selected for each pixel of the processing result image, and the pixel-shifting of the pixels of the viewpoint images and the addition are performed so as to focus on the selected focusing plane.

The selection of one focusing plane from the first focusing plane and the second focusing plane is equivalent to the setting of the reference shift amount BV.

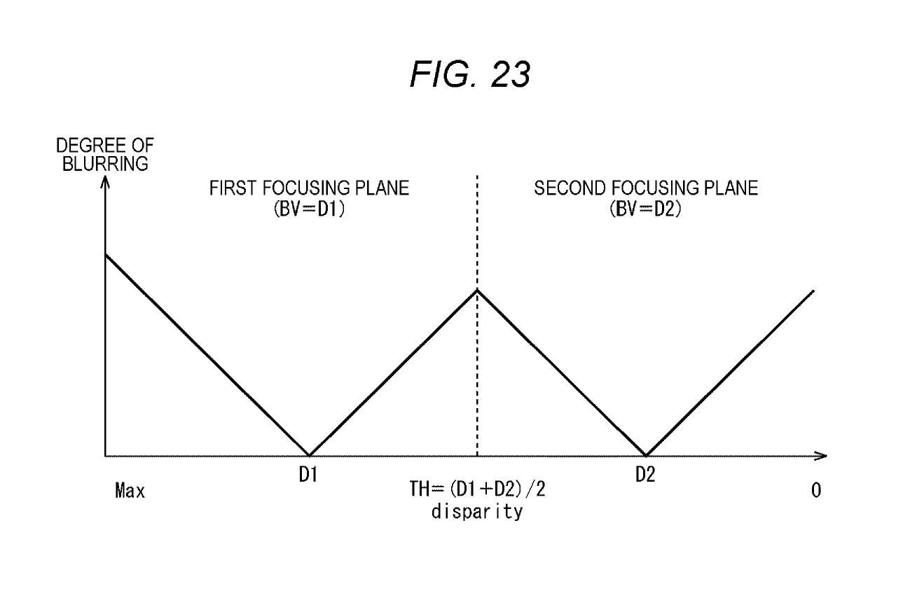

FIG. 23 is a diagram for explaining an example of a selection method of selecting one focusing plane from the first focusing plane and the second focusing plane.

In other words, FIG. 23 is a diagram for explaining an example of a setting method for the reference shift amount BV in the multifocal refocusing mode.

In the multifocal refocusing mode, the focusing plane can be selected according to the disparities of the pixels of the viewpoint image viewed from the viewpoint of the processing result image, in other words, according to the disparities of the pixels of the reference image in the present embodiment.

In FIG. 23, the horizontal axis represents (the magnitude) of the disparity of the pixels of the reference image, and the vertical axis represents the degree of blurring of each pixel of the processing result image at the same position as each pixel of the reference image having each disparity.

Furthermore, in FIG. 23, a threshold value TH is set between the disparity D1 of the first focusing plane and the disparity D2 of the second focusing plane. The threshold value TH is, for example, the average value (D1+D2)/2 of the disparity D1 of the first focusing plane and the disparity D2 of the second focusing plane.

In FIG. 23, the first focusing plane is selected in a case where the viewpoint image of the viewpoint of the processing result image, in other words, the registration disparity RD (hereinafter, also referred to as registration disparity RD of the attention pixel) of the pixel at the same position as an attention pixel in the reference image in the present embodiment is larger than (or equal to or greater than) the threshold value TH. Alternatively, the second focusing plane is selected in a case where the registration disparity RD of the attention pixel is equal to or less than (or smaller than) the threshold value TH.

In other words, in a case where the registration disparity RD of the attention pixel is larger than the threshold value TH, the reference shift amount BV is set according to the disparity D1 of the first focusing plane. Alternatively, in a case where the registration disparity RD of the attention pixel is equal to or less than the threshold value TH, the reference shift amount BV is set according to the disparity D2 of the second focusing plane.

As described above, by employing the average value (D1+D2)/2 of the disparity D1 of the first focusing plane and the disparity D2 of the second focusing plane as the threshold value TH, the focusing plane closer to an actual real space point appearing in the attention pixel is selected out of the first focusing plane and the second focusing plane. In other words, the reference shift amount BV for focusing the focusing plane closer to the actual real space point appearing in the attention pixel out of the first focusing plane and the second focusing is set.

Here, the actual real space point appearing in the attention pixel means a real space point appearing in the pixel at the same position as the attention pixel in the captured image that could be obtained if image capturing were performed from the viewpoint of the processing result image, and is a real space point appearing in the pixel at the same position as attention pixel in the reference image in the present embodiment.

Note that, in a case where the average value (D1+D2)/2 of the disparity iD of the first focusing plane and the disparity D2 of the second focusing plane is employed as the threshold value TH to set the reference shift amount BV and the pixel-shifting the pixels of the viewpoint images according to the reference shift amount BV and the addition are performed, the attention pixel in which the real space point close to the first focusing plane appears is blurred proportional to the distance between the real space point and the first focusing plane (the difference between (the magnitude of) the disparity of the real space point and the disparity D1) as shown in FIG. 23. Similarly, the attention pixel in which the real space point close to the second focusing plane appears is blurred proportional to the distance between the real space point and the second focusing plane (the difference between the disparity of the real space point and the disparity D2) as shown in FIG. 23.

As a result, continuously changing blurring can be realized in the processing result image.

Note that the threshold value TH can employ a value other than the average value (D1+D2)/2 of the disparity D1 of the first focusing plane and the disparity D2 of the second focusing plane. In other words, for example, any value between the disparity D1 of the first focusing plane and the disparity D2 of the second focusing plane can be employed as the threshold value TH.

For example, in a case where the disparity D2 of the second focusing plane is employed as the threshold value TH, an image, in which special blurring has occurred, can be obtained as the processing result image. The special blurring is a state where the pixel in which the real space farther from the first focusing plane appears becomes more blurred and a state where the pixel in which the real space on the second focusing plane appears suddenly comes into focus.

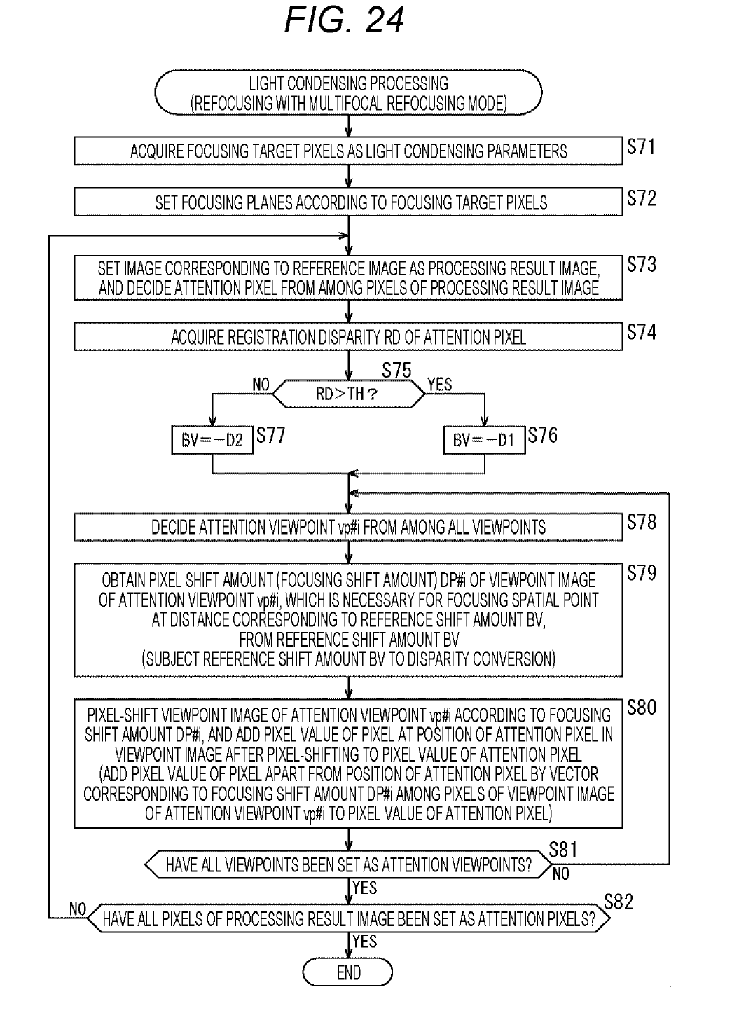

FIG. 24 is a flowchart for explaining an example of the light condensing processing performed by the light condensing processing unit 33 in a case where the refocusing mode is set to the multifocal refocusing mode.

In step S71, the light condensing processing unit 33 acquires the focusing target pixels as the light condensing parameters from the parameter setting unit 34 as in step S51 in FIG. 21, and the processing proceeds to step S72.

In other words, for example, the reference image PL1 or the like among the capturing images PL1 to PL7 captured by the cameras 21₁ to 21₇ is displayed on the display apparatus 13. When the user designates the plurality of positions on the reference image PL1, the parameter setting unit 34 sets the plurality of pixels at the plurality of positions designated by the user as the focusing target pixels and supplies the light condensing processing unit 33 with (the information representing) the plurality of focusing target pixels as the light condensing parameters.

In the multifocal refocusing mode, the user can designate a plurality of positions on the reference image PL1, and a plurality of pixels equal to the number of positions designated by the user are also set as the focusing target pixels.

Note that, in FIG. 24, in order to simplify the explanation, for example, the user designates two positions on the reference image PL1, and two pixels at the two positions designated by the user are set as the focusing target pixels.

In step S71, the light condensing processing unit 33 acquires the focusing target pixels of two pixels supplied from the parameter setting unit 34 as described above.

In step S72, the light condensing processing unit 33 sets, as the focusing planes, two planes passing through two respective spatial points (designated spatial points) appearing in focusing target pixels of two pixels according to the focusing target pixels of the two pixels acquired from the parameter setting unit 34.

In other words, the light condensing processing unit 33 obtains (the positions (x, y, z)) of the designated spatial points appearing in the focusing target pixels from the parameter setting unit 34 by using the positions (x, y) of the focusing target pixels and the registration disparity RD of the disparity map from the disparity information generation unit 31. Then, the light condensing processing unit 33 obtains the planes, which pass through the designated spatial points appearing in the focusing target pixels and are perpendicular to the z axis, and sets the planes as the focusing planes.

Here, for example, as described with FIG. 22, the first focusing plane of the disparity D1 with a large value and the second focusing plane of the disparity D2 with a small value are set.

Thereafter, the processing proceeds from step S72 to step S73, and the light condensing processing unit 33 sets, for example, the image corresponding to the reference image as the processing result image as in step S33 in FIG. 13. Moreover, the light condensing processing unit 33 decides, as the attention pixel, one pixel among the pixels that have not yet been decided as the attention pixels from among the pixels of the processing result image, and the processing proceeds from step S73 to step S74.

In step S74, the light condensing processing unit 33 acquires the registration disparity RD ((the magnitude of) the disparity of the pixel at the same position as the attention pixel in the captured image that could be obtained if image capturing were performed from the viewpoint of the processing result image) of the attention pixel from the disparity map from the disparity information generation unit 31, and the processing proceeds to step S75.

In steps S75 to S77, the light condensing processing unit 33 sets the reference shift amount BV according to the registration disparity RD of the attention pixel and the first focusing plane or the second focusing plane.

In other words, in step S75, the light condensing processing unit 33 determines whether or not the registration disparity RD of the attention pixel is larger than the threshold value TH. For example, as described with FIG. 23, the threshold value TH can be set to the average value (D1+D2)/2 of the disparity D1 of the first focusing plane and the disparity D2 of the second focusing plane, or the like according to the disparity D1 of the first focusing plane and the disparity D2 of the second focusing plane.

In a case where it has been determined in step S75 that the registration disparity RD of the attention pixel is larger than the threshold value TH, in other words, for example, in a case where the registration disparity RD of the attention pixel is close to the disparity D1 with a large value out of the disparity D1 of the first focusing plane and the disparity D2 of the second focusing plane, the processing proceeds to step S76.

In step S76, according to the disparity D1 close to the registration disparity RD of the attention pixel out of the disparity D1 of the first focusing plane and the disparity D2 of the second focusing plane, the light condensing processing unit 33 sets, for example, negative one times the disparity D1 as the reference shift amount BV, and the processing proceeds to step S78.

Alternatively, in a case where it has been determined in step S75 that the registration disparity RD of the attention pixel is not larger than the threshold value TH, in other words, for example, in a case where the registration disparity RD of the attention pixel is close to the disparity D2 with a small value out of the disparity D1 of the first focusing plane and the disparity D2 of the second focusing plane, the processing proceeds to step S77.

In step S77, according to the disparity D2 close to the registration disparity RD of the attention pixel out of the disparity D1 of the first focusing plane and the disparity D2 of the second focusing plane, the light condensing processing unit 33 sets, for example, negative one times the disparity D2 as the reference shift amount BV, and the processing proceeds to step S78.

In step S78, the light condensing processing unit 33 decides, as the attention viewpoint vp#i, one viewpoint vp#i that has not yet been decided as the attention viewpoint among the viewpoints of the viewpoint images from the interpolation unit 32, and the processing proceeds to step S79.

In step S79, the light condensing processing unit 33 obtains the focusing shift amount DP#i of the viewpoint image of the attention viewpoint vp#i, which is necessary for focusing the spatial point apart in the depth direction by the distance corresponding to the reference shift amount BV, from the reference shift amount BV.

In other words, the light condensing processing unit 33 subjects the reference shift amount BV to the disparity conversion by using the direction from the reference viewpoint to the attention viewpoint vp#i and acquires the value obtained as a result of the disparity conversion as the focusing shift amount DP#i of the viewpoint image of the attention viewpoint vp#i.

Thereafter, the processing proceeds from step S79 to step S80, and the light condensing processing unit 33 pixel-shifts each pixel of the viewpoint image of the attention viewpoint vp#i according to the focusing shift amount DP#i and adds the pixel value of the pixel at the position of the attention pixel in the viewpoint image after the pixel-shifting to the pixel value of the attention pixel.

In other words, the light condensing processing unit 33 adds, to the pixel value of the attention pixel, the pixel value of the pixel apart from the position of the attention pixel by a vector (here, for example, negative one times the focusing shift amount DP#i) corresponding to the focusing shift amount DP#i among the pixels of the viewpoint image of the attention viewpoint vp#i.

Then, the processing proceeds from step S80 to step S81, and the light condensing processing unit 33 determines whether or not all the viewpoints of the viewpoint images from the interpolation unit 32 have been set as the attention viewpoints.

In a case where it has been determined in step S81 that not all the viewpoints of the viewpoint images from the interpolation unit 32 have been yet set as the attention viewpoints, the processing returns to step S78, and the similar processing is repeated thereafter.

Furthermore, in a case where it has been determined in step S81 that all the viewpoints of the viewpoint images from the interpolation unit 32 have been set as the attention viewpoints, the processing proceeds to step S82.

In step S82, the light condensing processing unit 33 determines whether or not all the pixels of the processing result image have been set as the attention pixels.

In a case where it has been determined in step S82 that not all the pixels of the processing result image have been yet set as the attention pixels, the processing returns to step S73, the light condensing processing unit 33 newly decides, as the attention pixel, one pixel among the pixels that have not yet been decided as the attention pixels from among the pixels of the processing result image as described above, and the similar processing is repeated thereafter.

Furthermore, in a case where it has been determined in step S82 that all the pixels of the processing result image have been set as the attention pixels, the light condensing processing unit 33 outputs the processing result image and ends the light condensing processing.

Note that distances in the depth direction, in other words, disparities are different between the first focusing plane and the second focusing plane (a plurality of focusing planes) set in the multifocal refocusing mode.

Then, in the multifocal refocusing mode, according to the registration disparity RD of the attention pixel, the reference shift amount BV is set to, for example, the disparity close the registration disparity RD of the attention pixel out of the disparity D1 of the first focusing plane and the disparity D2 of the second focusing plane.

In other words, in the multifocal refocusing mode, the reference shift amount BV is set for each attention pixel.

Conversely, by setting the reference shift amount BV for each attention pixel, it is possible to select one focusing plane from a plurality of focusing planes with different distances in the depth direction in the multifocal refocusing mode by (the registration disparity RD of) the attention pixel and perform refocusing for each attention pixel to focus on the focusing plane selected for the attention pixel.

Note that the first focusing plane and the second focusing plane are set as two focusing planes with different disparities (distances in the depth direction) in FIG. 24, but three or more focusing planes with different disparities can be set in the multifocal refocusing mode.

In a case where three or more focusing planes are set, for example, each of the disparities of the three or more focusing planes is compared with the registration disparity RD of the attention pixel, and the reference shift amount BV can be set according to the disparity of the focusing plane closest to the registration disparity RD of the attention pixel.

Furthermore, in the multifocal refocusing mode, for example, it is possible to set a focusing plane with a distance in the depth direction corresponding to each of all the registration disparities RD registered in the disparity map according to the manipulation of the user, or the like.

In this case, by setting the reference shift amount BV according to the disparity of the focusing plane closest to (the distance corresponding to) the registration disparity RD of the attention pixel, it is possible to obtain the processing result image of deep focus with an improved signal-to-noise ratio (S/N) compared with the captured images PL#i.

Moreover, the planes perpendicular to the z axis are set as the focusing planes in the multifocal refocusing mode in the present embodiment, but in addition, for example, planes not perpendicular to the z axis can be set as the focusing planes.

Note that the reference viewpoint is employed as the viewpoint of the processing result image in the present embodiment, but a point other than the reference viewpoint, in other words, for example, any point in the synthetic apertures of the virtual lens, or the like can be employed as the viewpoint of the processing result image.

<Description of Computer to which Present Technology is Applied>

Next, a series of processings of the image processing apparatus 12 described above can be performed by hardware or can be performed by software. In a case where the series of processings is performed by the software, a program constituting that software is installed in a general-purpose computer or the like.

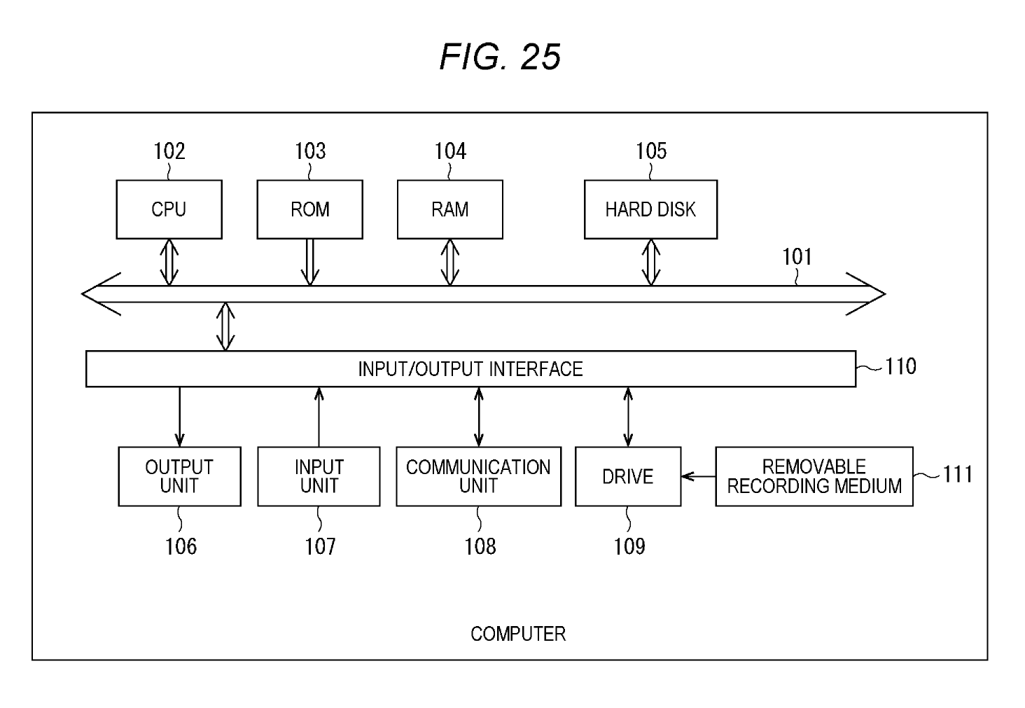

FIG. 25 is a block diagram showing a configuration example of a computer according to one embodiment, in which the program that executes the series of processings described above is installed.

The program can be recorded in advance in a hard disk 105 and a ROM 103 as recording media built into the computer.

Alternatively or additionally, the program can be stored (recorded) in a removable recording medium 111. Such a removable recording medium 111 can be provided as so-called package software. Here, examples of the removable recording medium 111 include a flexible disk, a compact disc read only memory (CD-ROM), a magneto optical (MO) disk, a digital versatile disc (DVD), a magnetic disk, a semiconductor memory, and the like.

Note that, in addition to installing the program in the computer from the removable recording medium 111 as described above, the program can be downloaded to the computer via a communication network or a broadcast network and installed in the built-in hard disk 105. In other words, for example, it is possible to transfer the program wirelessly from a download site to the computer via an artificial satellite for digital satellite broadcasting and to transfer the program wiredly to the computer via a network such as a local area network (LAN) or the Internet.

The computer has a built-in central processing unit (CPU) 102, and an input/output interface 110 is connected to the CPU 102 via a bus 101.

When a command is inputted by manipulating an input unit 107 by a user via the input/output interface 110, for example, the CPU 1102 executes the program stored in a read only memory (ROM) 103 according to the command. Alternatively, the CPU 102 loads the program stored in the hard disk 105 into a random access memory (RAM) 104 and executes the program.

Accordingly, the CPU 102 performs the processings according to the above-described flowcharts or the processings performed by configurations of the above-described block diagrams. Then, the CPU 102 outputs the processing results as necessary, for example, from an output unit 106 via the input/output interface 110, transmits the processing results from a communication unit 108, causes the hard disk 105 to record the processing results, or the like.

Note that the input unit 107 is constituted by a keyboard, a mouse, a microphone, and the like. Furthermore, the output unit 106 is constituted by a liquid crystal display (LCD), a speaker, and the like.

Here, in this specification, the processings performed by the computer according to the program do not have to be necessarily performed in time series along the order described in the flowcharts. In other words, the processings performed by the computer according to the program also include processings which are executed in parallel or individually (e.g., parallel processing or processing by an object).

Furthermore, the program may be processed by one computer (processor) or may be distributed to be processed by a plurality of computers. Moreover, the program may be transferred to a remote computer to be executed.

Moreover, in this specification, the system means a group of a plurality of constituents (apparatuses, modules (components), and the like), and it does not matter whether or not all the constituents are in the same housing. Therefore, a plurality of apparatuses, which are housed in separate housings and connected via a network, and one apparatus, in which a plurality of modules are housed in one housing, are both systems.

Note that the embodiments of the present technology are not limited to the above-described embodiments, and various modifications can be made in a scope without departing from the gist of the present technology.

For example, the present technology can adopt the configuration of cloud computing in which one function is shared and collaboratively processed by a plurality of apparatuses via a network.

Furthermore, each step described in the above-described flowcharts can be executed by one apparatus or can also be shared and executed by a plurality of apparatuses.

Moreover, in a case where a plurality of processings are included in one step, the plurality of processings included in the one step can be executed by one apparatus or can also be shared and executed by a plurality of apparatuses.

Furthermore, the effects described in the present specification are merely examples and are not limited, and other effects may be exerted.

Note that the present technology can adopt the following configurations.

<1>

An image processing apparatus including a light condensing processing unit that sets a shift amount for each of pixels of a processing result image when performing light condensing processing of generating the processing result image focused on a plurality of focusing points with different distances in a depth direction by setting the shift amount for shifting pixels of images of a plurality of viewpoints, and shifting the pixels of the images of the plurality of the viewpoints according to the shift amount to be added.

<2>

The image processing apparatus according to <i>, in which the light condensing processing unit sets a plane with a changing distance in the depth direction as a focusing plane constituted by a group of spatial points to be focused and sets the shift amount for focusing the processing result image on the focusing plane for each of the pixels of the processing result image.

<3>

The image processing apparatus according to <2>, in which the light condensing processing unit sets, as the focusing plane, a plane passing through a spatial point appearing in a pixel at a designated position among the pixels of the images.

<4>

The image processing apparatus according to <3>, in which the light condensing processing unit sets, as the focusing plane, a plane that passes through two spatial points appearing in pixels at two designated positions among the pixels of the images and is parallel to a vertical direction.

<5>

The image processing apparatus according to <3>, in which the light condensing processing unit sets, as the focusing plane, a plane that passes through two spatial points appearing in pixels at two designated positions among the pixels of the images and is parallel to a horizontal direction.

<6>

The image processing apparatus according to <1>, in which the light condensing processing unit sets a plurality of planes with different distances in the depth direction as focusing planes constituted by a group of spatial points to be focused and sets the shift amount for focusing the processing result image on the focusing planes for each of the pixels of the processing result image.

<7>

The image processing apparatus according to <6>, in which the light condensing processing unit sets, as the focusing planes, a plurality of planes passing through a plurality of respective spatial points appearing in pixels at a plurality of designated positions among the pixels of the images.

<8>

The image processing apparatus according to <7>, in which the light condensing processing unit sets, as the focusing planes, a plurality of planes that pass through a plurality of respective spatial points appearing in pixels at a plurality of designated positions among the pixels of the images and have unchanging distances in the depth direction.

<9>

The image processing apparatus according any one of <6> to <8>, in which the light condensing processing unit sets the shift amount, which is for focusing on one focusing plane among the plurality of the focusing planes, for each of the pixels of the processing result image according to disparity information on the images of the plurality of the viewpoints.

<10>

The image processing apparatus according to <9>, in which the light condensing processing unit sets the shift amount, which is for focusing on one focusing plane close to a spatial point appearing in a pixel of the processing result image among the plurality of the focusing planes, for each of the pixels of the processing result image according to the disparity information on the images of the plurality of the viewpoints.

<11>

The image processing apparatus according to any one of <1> to <10>, in which the images of the plurality of the viewpoints include a plurality of capturing images captured by a plurality of cameras.

<12>

The image processing apparatus according to <11>, in which the images of the plurality of the viewpoints include the plurality of the captured images and a plurality of interpolation images generated by interpolation using the captured images.

<13>

The image processing apparatus according to <12>, further including:

a disparity information generation unit that generates disparity information on the plurality of the captured images; and

an interpolation unit that generates the plurality of the interpolation images of different viewpoints by using the captured images and the disparity information.

<14>

An image processing method including a step of setting a shift amount for each of pixels of a processing result image when performing light condensing processing of generating the processing result image focused on a plurality of focusing points with different distances in a depth direction by setting the shift amount for shifting pixels of images of a plurality of viewpoints, and shifting the pixels of the images of the plurality of the viewpoints according to the shift amount to be added.

<15>

A program for causing a computer to function as a light condensing processing unit that sets a shift amount for each of pixels of a processing result image when performing light condensing processing of generating the processing result image focused on a plurality of focusing points with different distances in a depth direction by setting the shift amount for shifting pixels of images of a plurality of viewpoints, and shifting the pixels of the images of the plurality of the viewpoints according to the shift amount to be added.

### REFERENCE SIGNS LIST

11 Image capturing apparatus
12 Image processing apparatus
13 Display apparatus
21₁ to 21₇, 21₁₁ to 21₁₉ Camera unit
31 Disparity information generation unit
32 Interpolation unit
33 Light condensing processing unit
34 Parameter setting unit
101 Bus
102 CPU
103 ROM
104 RAM
105 Hard disk
106 Output unit
107 Input unit
108 Communication unit
109 Drive
110 Input/output interface
111 Removable recording medium

1. An image processing apparatus comprising a light condensing processing unit that sets a shift amount for each of pixels of a processing result image when performing light condensing processing of generating the processing result image focused on a plurality of focusing points with different distances in a depth direction by setting the shift amount for shifting pixels of images of a plurality of viewpoints, and shifting the pixels of the images of the plurality of the viewpoints according to the shift amount to be added.

2. The image processing apparatus according to claim 1, wherein the light condensing processing unit sets a plane with a changing distance in the depth direction as a focusing plane constituted by a group of spatial points to be focused and sets the shift amount for focusing the processing result image on the focusing plane for each of the pixels of the processing result image.

3. The image processing apparatus according to claim 2, wherein the light condensing processing unit sets, as the focusing plane, a plane passing through a spatial point appearing in a pixel at a designated position among the pixels of the images.

4. The image processing apparatus according to claim 3, wherein the light condensing processing unit sets, as the focusing plane, a plane that passes through two spatial points appearing in pixels at two designated positions among the pixels of the images and is parallel to a vertical direction.

5. The image processing apparatus according to claim 3, wherein the light condensing processing unit sets, as the focusing plane, a plane that passes through two spatial points appearing in pixels at two designated positions among the pixels of the images and is parallel to a horizontal direction.

6. The image processing apparatus according to claim 1, wherein the light condensing processing unit sets a plurality of planes with different distances in the depth direction as focusing planes constituted by a group of spatial points to be focused and sets the shift amount for focusing the processing result image on the focusing planes for each of the pixels of the processing result image.

7. The image processing apparatus according to claim 6, wherein the light condensing processing unit sets, as the focusing planes, a plurality of planes passing through a plurality of respective spatial points appearing in pixels at a plurality of designated positions among the pixels of the images.

8. The image processing apparatus according to claim 7, wherein the light condensing processing unit sets, as the focusing planes, a plurality of planes that pass through a plurality of respective spatial points appearing in pixels at a plurality of designated positions among the pixels of the images and have unchanging distances in the depth direction.

9. The image processing apparatus according to claim 6, wherein the light condensing processing unit sets the shift amount, which is for focusing on one focusing plane among the plurality of the focusing planes, for each of the pixels of the processing result image according to disparity information on the images of the plurality of the viewpoints.

10. The image processing apparatus according to claim 9, wherein the light condensing processing unit sets the shift amount, which is for focusing on one focusing plane close to a spatial point appearing in a pixel of the processing result image among the plurality of the focusing planes, for each of the pixels of the processing result image according to the disparity information on the images of the plurality of the viewpoints.

11. The image processing apparatus according to claim 1, wherein the images of the plurality of the viewpoints include a plurality of capturing images captured by a plurality of cameras.

12. The image processing apparatus according to claim 11, wherein the images of the plurality of the viewpoints include the plurality of the captured images and a plurality of interpolation images generated by interpolation using the captured images.

13. The image processing apparatus according to claim 12, further comprising:
a disparity information generation unit that generates disparity information on the plurality of the captured images; and
an interpolation unit that generates the plurality of the interpolation images of different viewpoints by using the captured images and the disparity information.

14. An image processing method comprising a step of setting a shift amount for each of pixels of a processing result image when performing light condensing processing of generating the processing result image focused on a plurality of focusing points with different distances in a depth direction by setting the shift amount for shifting pixels of images of a plurality of viewpoints, and shifting the pixels of the images of the plurality of the viewpoints according to the shift amount to be added.

15. A program for causing a computer to function as a light condensing processing unit that sets a shift amount for each of pixels of a processing result image when performing light condensing processing of generating the processing result image focused on a plurality of focusing points with different distances in a depth direction by setting the shift amount for shifting pixels of images of a plurality of viewpoints, and shifting the pixels of the images of the plurality of the viewpoints according to the shift amount to be added.
